(19) United States
(12) Patent Application Publication
(10) Pub. No.: US 2023/0200580 A1
(43) Pub. Date: Jun. 29, 2023

(54) CENTRIFUGAL COFFEE BREWER

(71) Applicant: SPINN HOLDING B.V., Amsterdam (NL)

(72) Inventors: Serge Alfred Johan DE WARRIMONT, Amsterdam (NL); Roderick DE RODE, Amsterdam (NL); Johan NIEUWENDIJK, Utrecht (NL); Wouter BEEFTINK, Pannerden (NL)

(21) Appl. No.: 17/927,436

(22) PCT Filed: Apr. 30, 2021
(86) PCT No.: PCT/EP2021/061435

§ 371 Date: Nov. 23, 2022

(30) Foreign Application Priority Data
May 25, 2020 (NL) 2025661

(51) Int. Cl. A47J 31/22; A47J 31/60; A47J 31/44; H05B 3/22

(52) U.S. Cl. CPC A47J 31/22; A47J 31/60; A47J 31/4403; H05B 3/22

(57) ABSTRACT

The present invention relates to a centrifugal coffee brewing device, comprising: a centrifugal brewing unit constructed to brew coffee, the centrifugal brewing unit comprising: a chamber element comprising a bottom wall and a roof portion, a cylinder element comprising a filter—a heater element, a gutter element which defines a gutter located around the centrifugal brewing unit, via which brewed coffee travels to a coffee outlet, a residue deflection member for guiding coffee residue which is ejected from the centrifugal brewing unit into a residue tray, wherein the residue deflection member is heated by the heater element.

### FIELD OF THE INVENTION

The present invention relates to a centrifugal coffee brewer and its components. Centrifugal coffee brewers are known.

### BACKGROUND OF THE INVENTION

WO2019031964A1 (herein D1) discloses a centrifugal coffee brewing device, comprising a spinning assembly that is used as a brewing chamber. This spinning assembly comprises a chamber element with a roof and a lower end and is closed off on its sides by a cylindrical filter element. In operation, a coffee bed is formed over the height of this filter element and is wettened by hot water, extracting the coffee beverage. Upon completion of the beverage, the filter element is removed and the coffee bed is expelled due to the centrifugal forces acting on the coffee bed as a result of the rotation. It was found that this device has a couple of drawbacks.

A drawback of D1 is that the rapid rotation of the spinning assembly can cause vibrations due to the unbalanced nature of rotating components. It was found that the machine of D1 suffers from this type of vibration because the distribution of the brewing ingredients, i.e. the hot water and the ground coffee, in the rotational assembly will differ for each cup of coffee. The varying distribution results in an imbalance each time a cup of coffee is made. Hence, the vibrations are inherent to such the centrifugal coffee brewing device.

Another drawback of the device is that, when the beverage has been extracted from the ground coffee, the hot and wet coffee residue is expelled and collides with a residue impact wall. This wall is configured to direct the residue down into the residue tray. Because the environment in which the residue impact wall is positioned, is a humid one, the residue tends to stick to the residue impact wall that has also become wet. This, in turn, leads to a build-up of coffee residue on the residue impact wall that eventually blocks the centrifugal brewing chamber.

The sticking of coffee residue also occurs on the skirt which is provided below the residue impact wall. Because a lower part of the skirt is constricted and has a surface which slightly faces upward, the problem is even greater at the lower, constricted part of the skirt. The coffee residue collects in particular on the upward facing surface of the skirt and clogs up the machine. This problem is serious and attempts to solve this problem have failed so far.

Another disadvantage associated with the centrifugal coffee brewing device of D1 is that some of the expelled coffee is able to reach the residue tray compartment. This creates an area polluted by coffee residue around the residue tray.

Another drawback associated with D1 is the relative difficulty with which the water tank is placed on the device. Because a coffee brewing device is usually facing towards its user, the location of the water tank on the back of the device, while being advantageous in a spatial sense, does not contribute to the ease of use of the coffee brewing device.

It was also recognized that the device of D1 does not comprise a safety mechanism. This makes it possible for a user to reach the rotating components with their hands while the device is in operation, in particular via the compartment for the residue tray.

Further centrifugal coffee brewing devices have been disclosed in the following documents: FR2236456, BE823309A, WO2012069986A1. These documents disclose primitive versions of centrifugal coffee brewing devices. To the best of the knowledge of the applicant, none of these (or similar devices) have reached the market.

### OBJECTS OF THE INVENTION

It is an object of the invention to provide a device which suffers less from at least one of the abovementioned drawbacks.

### SUMMARY OF THE INVENTION

The centrifugal coffee brewing device as disclosed herein provides several independent improvements over the prior art that may lessen the abovementioned drawbacks.

### Heated Skirt

In a first aspect, the centrifugal coffee brewing device comprises:
   a centrifugal brewing unit constructed to brew coffee, the centrifugal brewing unit comprising:
      a chamber element comprising a bottom wall and a roof portion,
      a cylinder element comprising a filter,
   a residue deflection member for deflecting coffee residue which is ejected from the centrifugal brewing unit, wherein the coffee residue is deflected in a downward direction,
   a skirt positioned below the residue deflection member and extending downward from the residue deflection member, wherein the skirt is configured for further guiding the deflected coffee residue downward into a residue tray,
   a heater element, wherein the heater element heats the skirt, thereby preventing formation of condensation on the skirt and preventing sticking of coffee residue to the skirt.

During the development of a centrifugal coffee brewing device it was found that the humidity level inside the device has detrimental effects to the performance of the coffee brewing device.

This manifested itself in the expelled wet coffee residue sticking to the skirt and to the residue deflection member. Because the residue deflection member is used to deflect the expelled coffee downward and the skirt is used to further guide the coffee residue into the residue tray, a build-up of coffee residue in this location reduces the user-friendliness. Every so often, the skirt must be cleaned in order for the centrifugal brewing unit not to fill up with residue. The coffee residue on the skirt can clog up the machine.

By analysing the coffee brewing process, it was found that the vaporized moisture inside the device condensates on the skirt and on the residue deflection member. This condensation causes the expelled residue to stick to the residue deflection member.

The heating of the residue deflection member and in particular the skirt by a heater element prevents the condensation of the moisture inside the centrifugal coffee brewing device on the residue deflection member and in particular on the skirt or significantly reduces the condensation. This in turn prevents significantly or reduces the sticking of expelled coffee residue to the residue deflection member and the skirt. It was found that with the measure of heating the skirt and preferably also the residue deflection member a difficult problem has been resolved. The heater element may directly or indirectly heat the skirt. It is noted that where the term prevent is used, the applicant recognises that a small number of coffee grains and/or condensation droplets may still be present.

In an embodiment, the skirt comprises a lower part which is constricted and which faces upwardly and wherein the heater element heats the constricted lower part, thereby avoiding formation of condensation on the constricted lower part and avoiding sticking of coffee residue to the constricted lower part.

It was found that the sticking of coffee residue on the lower part of the skirt is difficult to prevent because the lower part of the skirt is slightly constricted and therefore the inner surface of the skirt faces slightly upwards. In particular on this location the coffee residue tends to stick and stay there. The heating of the lower constricted part solves this problem.

In an embodiment, the skirt is heated to a temperature of at least 50 degrees Celsius by the heater element. It was found that at this temperature there is no or very little condensate on the skirt and the problem of sticking coffee residue disappears.

In an embodiment, the residue deflection member and the skirt are integrated and form a single ring-shaped residue guiding component, wherein the ring-shaped residue guiding component is manufactured from a heat conducting material, preferably metal, preferably aluminium, wherein the entire residue guiding component is heated by the heater element.

In an embodiment, the residue deflection member and the skirt are separate parts which are manufactured from a heat conducting material, preferably metal, wherein said parts are connected to one another in a heat conducting manner allowing one heater to heat both parts. In an embodiment, the residue deflection member and the skirt are manufactured from aluminium. It was found that in this way, a single heater can heat both the skirt and the residue deflection member. Thermal conduction allows the heat to spread from the point of entry to both parts.

In an embodiment:
a) the heater element is integrated with the skirt or in contact with the skirt and directly heats the skirt,
   and/or
b) the heater element is integrated with the residue deflection member or is in contact with the residue deflection member, wherein the heater element indirectly heats the skirt via conduction of heat through the residue deflection member to the skirt. The ‘and’ branch includes having more than one heater. In case of a single heater, it can be placed in various locations. It can directly heat the skirt and indirectly heat the residue deflection member or vice versa.

In an embodiment, the heater element also heats the residue deflection member. Advantageously, the heating of the residue deflection member prevents condensation of moisture inside the centrifugal coffee brewing device on the residue deflection member, thereby reducing sticking of expelled coffee residue to the residue deflection member. In this way the entire path which the coffee residue needs to travel from the chamber to the residue tray is kept clean.

In an embodiment, the centrifugal coffee brewing device further comprises a gutter element which defines a gutter located around the centrifugal brewing unit, via which brewed coffee travels to a coffee outlet, wherein the gutter and the residue deflection member are integrated into one component or wherein the residue deflection member and gutter are separate elements which are in contact with one another in order to allow heat to transfer between the residue deflection member and the gutter. Advantageously, one heater can heat both the gutter and the residue deflection member in order to ensure that 1) the coffee which is served is hot and 2) that the skirt with additionally the residue deflection member stays clean.

In an embodiment, the heater element is part of the gutter and is configured to also heat the gutter. This advantageously allows the use of an existing component, i.e. a gutter with a heater, for a further function namely keeping the skirt and optionally the residue deflection member clean. This may require that more electrical power is to the heater element so that both functions can be carried out adequately.

In an embodiment, the skirt is constricted and a part of an inner surface of the skirt faces inwards and upwards. In an embodiment, the residue deflection member forms an inwardly facing wall which faces inwards and downwards. The term constricted means that the skirt has an inner diameter which is smaller than the inner diameter of at least a lower part of the residue deflection member. The skirt is constricted near its lower end. This means that the inner diameter becomes smaller in a downward direction.

The constricted skirt has an advantage of allowing a smaller overall device but a disadvantage in that coffee residue sticks to the upwardly directed inwardly facing surface.

In an embodiment, the skirt extends to a position below a bottom wall of the chamber element. It is typically the lower portion of the skirt which suffers most from the coffee residue sticking problem.

In an embodiment, the residue deflection member is heated to a temperature of at least 50 degrees Celsius by the heater element. This also prevents formation of condensate on the residue deflection member thereby preventing the sticking of coffee residue on the residue deflection member.

In addition to the skirt and/or the residue deflection member being heated, in one embodiment, at least one of the skirt and the residue deflection member is also coated with a non-sticking material.

In one embodiment, the non-sticking material is polytetrafluorethylene. In particular, the non-sticking material in Teflon.

In another embodiment, the gutter element is also heated by the heater element. The heater element may be located under the gutter.

In one embodiment, the gutter and the residue deflection member are integrated into one component. It was found that this increases thermal efficiency.

In another embodiment, the gutter and the residue deflection member are separate components. Herein, the heater element may be integrated into one component with the gutter and the separate components are in thermal contact with one another.

The centrifugal coffee brewing device may also comprise a control unit that controls the heater element.

In one embodiment, this control unit turns on the heater element substantially simultaneously to when the centrifugal coffee brewing device is turned on.

In one embodiment, the control unit turns off the heater element substantially simultaneously to when the centrifugal coffee brewing device is turned off.

In another embodiment, the control unit turns off the heater element less than 60 seconds after the centrifugal coffee brewing device has been turned off, in particular after 10-30 seconds, more in particular after 20 seconds.

In one embodiment, the heater element may be placed at a distance smaller than 10 cm from the centrifugal brewing unit and/or from the residue tray. The radiant heat from the heater element may then heat the centrifugal brewing unit and/or the residue tray.

By indirectly heating the residue tray, the humidity level therein and the moisture level in the coffee residue decreases. This results in a cleaner machine that needs less frequent maintenance than one with an unheated residue tray. The formation of moulds in the residue tray is also reduced.

The drying effect of the heater element is also increased by the rotation of the bottom wall of the centrifugal brewing unit. Because the centrifugal brewing unit spins to expel the coffee after the coffee making process and spins to a halt afterwards, the bottom wall may act as a blower.

In one embodiment, the bottom wall comprises at least one column that extends upwards towards the roof portion of the chamber element. Additionally, the bottom wall may also comprise at least one protrusion that extends downwards.

The columns and protrusions on the bottom wall push the air—which is heated by the heater element—around while the bottom wall comes to a halt; the moving hot air increases the drying of inside of the residue tray.

It will be understood that such a placement of the heater element can increase the temperature of the centrifugal brewing unit, resulting in a more efficient coffee brewing process. Additionally, the placement at a distance smaller than 10 cm to the residue tray may lead to the reduction of the humidity level inside the centrifugal coffee brewing device. This further reduces the build-up of coffee residue of the residue deflection member.

During operation, a method for brewing coffee using a centrifugal coffee brewing device comprising the steps of:
a) injecting hot water into the centrifugal brewing unit,
b) extracting a coffee beverage from a coffee bed that has formed over the filter and ejecting the coffee beverage into the gutter element,
c) moving the filter and ejecting the coffee residue from the centrifugal brewing unit,
d) guiding the coffee residue into the residue tray with the residue deflection member and the skirt, wherein the skirt is heated by the heater element, thereby preventing formation of condensation on the skirt and preventing sticking of coffee residue to the skirt.

The method provides the same advantages as the device according to the present invention.

In one embodiment of the method, the heater element also heats the gutter element and is integrated into the gutter element.

### Direct Injection Nozzle

In an independent aspect, the invention relates to a centrifugal coffee brewing device, comprising:
a centrifugal brewing unit constructed to brew coffee, the centrifugal brewing unit comprising:
   a chamber element comprising a bottom wall and a roof portion,
   a cylinder element comprising a filter,
a direct water injection nozzle comprising one or more nozzle outlets,
   wherein at least a portion of the direct water injection nozzle protrudes inside the centrifugal brewing unit to a position below the roof portion, and
   wherein the direct water injection nozzle is configured to inject water into the centrifugal brewing unit, and
   wherein the direct water injection nozzle is configured to wetten a coffee bed that has formed over the filter, and wherein the direct water injection nozzle sprays water over a horizontal distance, and wherein at least a portion of the injected water is directly sprayed upon the coffee bed.

In one embodiment, the roof portion comprises a stationary roof part and a rotary roof part, and wherein the stationary roof part defines a water inlet hole.

The direct water injection nozzle may be configured to distribute water over the height of the coffee bed.

It was found that the coffee bed changes thickness between small (espresso) and large (lungo, Americano) coffees. The use of a direct water injection nozzle provides an advantage over the known solution of spraying water onto a bottom wall or distribution table. By, at least in part, directly spraying water onto the coffee bed that has formed over the filter, the coffee bed is soaked more evenly.

An advantage of a more evenly wettened coffee bed is the increased flowability of the ground coffee and hot water mixture. Because of this increase, it is possible to distribute the coffee bed more evenly under the influence of centrifugal forces resulting from the rotating of a centrifugal brewing unit. This, in turn, leads to a reduction of the unbalance of the rotating components and this results in a reduction of unwanted vibrations.

A further advantage of a more evenly wettened coffee bed is an increase in total dissolved solids (TDS). Because more ground coffee particles are in contact with water, a larger amount of coffee beverage can be extracted from the same amount of ground coffee. This leads to the coffee brewing device being more economical and environmental friendly.

Additionally, the direct water injection nozzle makes less use of a bottom wall. This causes the water reaching the coffee bed to have a higher temperature because a smaller loss of thermal energy occurs.

In contrast to the impact on the bottom wall that causes the water flow to atomize, the use of a direct water injection nozzle reduces the amount of mist inside the centrifugal coffee brewing device. As a skilled person will understand, this reduces the humidity level inside the centrifugal coffee brewing device which is beneficial to its overall use.

In an embodiment, the direct water injection nozzle comprises at least one nozzle outlet oriented towards a centre-axis of the bottom wall, being configured to, at least partially, clean the bottom wall.

In one embodiment, the direct water injection nozzle protrudes through the water inlet hole of the stationary roof part and is connected to the inlet channel outside of the centrifugal brewing unit. In particular, a water inlet channel may extend towards the stationary roof part but remains outside of the chamber. The water injection nozzle may then protrude through the water inlet hole of the stationary roof, wherein the water inlet channel is connected to the portion of the direct water injection nozzle that protrudes outside of the chamber.

In another embodiment, the inlet channel protrudes through the water inlet hole into the centrifugal brewing unit and the direct water injection nozzle is connected to the inlet channel inside the centrifugal brewing unit. In particular, the water inlet channel extends into the chamber and the direct water injection nozzle is connected inside the chamber to the portion of the water inlet channel that extends into the chamber.

The direct water injection nozzle may be connected to the roof portion of the chamber element.

The direct water injection nozzle may comprise a single nozzle outlet. The direct water injection nozzle may also comprise multiple nozzle outlets.

In an embodiment the direct water injection nozzle comprises multiple nozzle outlets. They may be spaced apart over a vertical distance.

Besides the vertical spacing of the nozzle outlets, the multiple nozzle outlets may be also be arranged in the same plane. In such a plane, the nozzle outlets may be oriented substantially parallel to each other.

The multiple nozzle outlets may also be oriented at angles with respect to each other, these angles may lie in a range between 0 and 45 degrees.

In one embodiment, the direct water injection nozzle comprises three nozzle outlets. In another embodiment, the direct water injection nozzle comprises four nozzle outlets.

In one embodiment, one nozzle outlet is angled towards the bottom wall and is configured to directly inject water against the bottom wall.

In one embodiment, the direct water injection nozzle comprises a separate nozzle portion and a separate coupling portion. Herein, the nozzle portion comprises one or more nozzle outlets and the coupling portion is configured to be coupled to the inlet channel. The nozzle portion and the coupling portion comprise means to be coupled together. In particular, the direct water injection nozzle comprises two separate parts that are configured to be coupled to each other. One part comprises means to be coupled to the inlet channel, for example a protrusion that snap fits into the inlet channel. The other part comprises one or more nozzle outlets.

The nozzle portion may be at least partially located in the centrifugal brewing unit and the coupling portion may be at least partially located outside the centrifugal brewing unit. Herein, the means to be coupled together of the nozzle portion and the coupling portion protrude and may engage each other through the water inlet hole. Herein, the coupling between the nozzle portion and the coupling portion also connects the direct water injection nozzle to the roof portion of the chamber element.

The coupling portion may be located on the upper side of the stationary roof part and the nozzle portion is located on the lower side of the stationary roof part when seen in side view, wherein the coupling means are coupled together through the water inlet hole.

In an embodiment, the coupling portion can be integrated in the stationary roof part.

Herein, the nozzle portion can be coupled to the coupling portion from within the centrifugal brewing unit. By removing the centrifugal brewing unit a user or repairman can access the nozzle portion to remove it for maintenance purposes. In particular, the centrifugal brewing unit and nozzle portion are removed in a downwards direction, i.e. where normally the residue tray would be placed. More in particular, the bottom wall of the centrifugal brewing unit can be removed first, providing access to the nozzle portion.

During operation the method for brewing coffee using a centrifugal coffee brewing device comprises the steps:
a) injecting hot water into a centrifugal brewing unit, the centrifugal brewing unit comprising:
   a chamber element comprising a bottom wall and a roof portion,
   a cylinder element comprising a filter
   wherein the direct water injection nozzle injects water into the centrifugal brewing unit, and
b) wettening a coffee bed that has formed over the height of the filter, wherein the direct injection nozzle sprays water over a horizontal distance towards the coffee bed and distributes water over the height of the coffee bed, and wherein at least a portion of the injected water is directly sprayed upon the coffee bed.

In one embodiment of the abovementioned method, the direct water injection nozzle protrudes through the water inlet hole and the direct water injection nozzle is connected to an inlet channel outside the chamber element.

The direct water injection nozzle may comprise a separate nozzle portion and a separate coupling portion, wherein the nozzle portion comprises one or more nozzle outlets and the coupling portion is configured to be coupled to the inlet channel, characterized in that the nozzle portion and the coupling portion comprise means to be coupled together and the coupling connects the direct water injection nozzle to the stationary roof part of the chamber element.

Residue Outlet with a Skirt

In another, independent aspect, the invention relates to a centrifugal coffee brewing device, comprising:
a housing having a tray opening,
a residue tray compartment located in the housing,
a removable residue tray for holding coffee residue, the residue tray being movable into and out of the residue tray compartment along a tray trajectory, the residue tray having an operational position in the residue tray compartment,
a centrifugal brewing unit constructed to brew coffee, the centrifugal brewing unit comprising a coffee residue outlet where coffee residue exits the centrifugal brewing unit,
a skirt connected to the coffee residue outlet,
wherein in the operational position the residue tray is positioned below the skirt,
wherein the residue tray is configured to engage the skirt,
wherein the residue tray comprises an upper edge, wherein at least a part of the upper edge is slanted, and wherein the skirt comprises a lower edge, wherein the lower edge is slanted, wherein the lower edge of the skirt and the upper edge of the residue tray are configured to mate and to form a fitting closure in the operational position of the residue tray.

Such a combination and engagement of the residue tray with the skirt results in a significant reduction of expelled coffee residue that is able to pollute the residue tray compartment and even the area outside the machine, otherwise known as the blow-out of residue.

In one embodiment, the lower edge of the skirt and the upper edge of the residue tray reach a lowest point at an end of the tray trajectory.

A part of the skirt may be manufactured out of a flexible material and/or a part of the residue tray may be made from a flexible material. The flexibility of part of the skirt and/or part of the residue tray can be used to create a tight fit between the skirt and the residue tray in the operational position. The flexibility of part of the skirt and/or part of the residue tray may also be used to limit the transfer of vibrations from the centrifugal brewing unit to the residue tray.

In one embodiment, to direct the expelled coffee residue into the residue tray, the skirt is a constricted skirt wherein the upper diameter of the skirt is larger than its lower diameter.

In one embodiment, the lower diameter of the skirt is smaller than the upper edge of the residue tray.

In order to prevent the formation of mould, either the residue tray or the skirt may comprise a hole to allow communication with the air outside the centrifugal coffee brewing device. In particular, such a hole may be located in the upper 20% of the residue tray wall. More in particular, it may be located in the lower 20% of the skirt.

In operation, the method for brewing coffee using a centrifugal coffee brewing device comprises the following steps:
a) positioning a residue tray in a residue tray compartment via a tray opening inside a housing of the centrifugal coffee brewing device into an operational position,
b) injecting hot water into a centrifugal brewing unit and extracting a coffee beverage from a centrifugal coffee brewing device, the centrifugal brewing unit comprising a coffee residue outlet where coffee residue exits the centrifugal brewing unit,
   wherein a skirt is connected to the coffee residue outlet,
c) ejecting the coffee residue from the coffee residue outlet and guiding the coffee residue into the residue tray via the skirt,
   wherein the residue tray is positioned below the skirt in the operational position and wherein the residue tray engages the skirt, characterized in that
   the residue tray comprises an upper edge, wherein at least a part of the upper edge is slanted, and wherein the skirt comprises a lower edge, wherein the lower edge is slanted, wherein the lower edge of the skirt and the upper edge of the residue tray are configured to mate and to form a tight fitting closure in the operational position of the residue tray.

### Pivot Table and Water Tank Including Filter

In another independent aspect, the invention relates to a centrifugal coffee brewing device, comprising:
a removable tank for holding a liquid, in particular water, the tank comprising:
   a wall which defines an inner volume,
   an opening at an upper side of the tank configured to allow filling of the tank,
   an outlet at a lower end of the tank for discharging the liquid, the outlet comprising a valve,
   one or more tank recesses provided in a lower end of the wall, wherein the tank recesses extend into the inner volume,
a pivotable tank support platform, the tank support platform being pivotable between an operational position and an inclined removal position, wherein the pivotable tank support platform comprises:
   one or more platform protrusions extending upwards and being configured to be positioned in the one or more tank recesses,
   one or more rotation stops configured to limit the rotation of the pivotable tank support platform between the operational position and the tank removal position,
an inlet configured to be coupled to the outlet,
wherein the lower end of the tank is configured to be placed on the pivotable tank support platform and to be uncoupled from the pivotable tank support platform when the pivotable tank support platform is in the removal position,

In one embodiment, the one or more platform protrusions are configured to be inserted into the one or more tank recesses in the removal position, wherein the platform protrusions form register pins and the recesses form register holes for keeping the water tank in the required position.

In another embodiment, the one or more tank recesses are configured to be placed over the one or more platform protrusions in the removal position, wherein the recesses form register holes and the platform protrusions form register pins for keeping the water tank in the required position.

The pivotable tank support platform may be pivotable about a horizontal pivot axis between an operational position and an inclined removal position.

The pivotable tank support platform in combination with the tank recesses and the platform protrusions enable the user of the centrifugal coffee brewing device to easily and conveniently place and remove the removable tank for cleaning and filling thereof. The location of the water tank on the back of a coffee brewing device therewith becomes a much smaller inconvenience.

By providing recesses in the removable tank and protrusions on the pivotable tank support platform, the tank may be placed with relative ease by the guidance of the recess-protrusion combination. Additionally, the ease of placement and rotation of the pivotable tank support platform reduce the risk of contact points between the water tank and the machine breaking off.

In one embodiment, the recesses and the protrusion are spaced at a similar distance.

In one embodiment, the removable tank comprises two recesses and the pivotable tank support platform comprises two protrusions.

In an embodiment, the outlet may be positioned between the two tank recesses and the inlet may be positioned between the two platform protrusions.

The outer dimension of the one or more platform protrusions may be the same as the inner dimensions of the one or more tank recesses; this creates a clearance fit. Such a clearance fit can be beneficial to the alignment of inlet and outlet.

To facilitate the placement of the removable tank onto the pivotable tank support platform, at least one protrusion may have a tapered end.

To align and centre the one or more recesses with the one or more protrusions, each protrusion may have an asymmetrically bevelled top. In an embodiment, the bevel may be placed under an angle of at least 45 degrees with respect to the vertical when the pivotable tank support platform is in the operational position. The bevel may face the centrifugal coffee brewing device,

In one embodiment, the removable tank comprises a lower end that forms a base upon which the tank can stand.

In one embodiment, the lower end comprises a skirt that extends circumferentially downwards. The pivotable tank support platform comprises a central portion and a circumferential portion, wherein the central portion is raised relatively to the circumferential portion. In the operational position, the skirt may engage the circumferential portion.

At least one protrusion has a length that is at least three times larger than its width.

To further facilitate the placement of the removable tank on the pivotable tank support platform, the pivotable tank support platform may comprise a resilient member. This resilient member biases the tank support platform towards the removal position when the tank has been removed. This results in at least one protrusion being oriented at least slightly outward in the removal position. The engagement of at least one recess by at least one protrusion then becomes easier.

In another embodiment, the abovementioned result may also be achieved by placing the centre of gravity of the pivotable tank support platform off-centre to the horizontal pivot axis and away from the centrifugal coffee brewing device.

In one embodiment, an opening is defined by the pivotable tank support platform. The inlet may protrude through this opening and, subsequently, the pivoting between the removal position and operational position of the pivotable tank support platform and removable tank pivots the outlet towards the inlet, the movement coupling the outlet to the inlet.

In another embodiment, the pivotable tank support platform comprises the inlet. The outlet of the removable tank is coupled to the inlet during the placement of the tank in the removal position.

The pivotable tank support platform may be provided at a rear side of the centrifugal coffee brewing device.

In one embodiment, the tank is configured to accommodate a removable filter that is configured to engage the tank outlet, the tank comprising a guide path defined by one or more guide elements for the removable filter, wherein the removable filter comprises:
one or more inlets,
one or more outlets,
a filter body,
means for engaging the valve or the tank outlet,

wherein the means for engaging the valve and the guide path are configured to keep the removable filter in an operational position of the filter in a substantially upright orientation of the tank, and

wherein the one or more outlets of the removable filter are in open communication with the tank valve, and

wherein the guide path allows the repeatable and accurate positioning of the removable filter onto the valve or the tank outlet and is configured to guide the removable filter towards the operational position of the filer from a position above the valve or the tank outlet.

In one embodiment, the tank recesses form the guide elements which define the guide path for the removable filter.

In operation, a method for brewing coffee using a centrifugal coffee brewing device, comprises the positioning of a removable tank for holding a liquid, in particular water, the tank comprising:
a wall which defines an inner volume,
an opening at an upper side of the tank configured to allow filling of the tank,
an outlet at a lower end of the tank for discharging the liquid, the outlet comprising a valve,
one or more tank recesses provided in a lower end of the wall, wherein the tank recesses extend into the inner volume,
onto a pivotable tank support platform, the tank support platform being pivotable an operational position and an inclined removal position, wherein the pivotable tank support platform comprises:
one or more platform protrusions,
one or more rotation stops configured to limit the rotation of the pivotable tank support platform between the operational position and the inclined removal position,
wherein the lower end of the tank is configured to be coupled to the pivotable tank support platform and to be uncoupled from the pivotable tank support platform,
wherein the at least one platform protrusion is configured to be inserted into the at least one tank recess in the removal position, wherein the platform protrusions form register pins and the recesses form register holes for keeping the water tank in the required position.

To facilitate the placement of the tank, the method may comprise the use of a pivotable tank support platform which is biased to pivot towards the removal position when the removable tank has been removed, wherein the pivoting is caused either by a resilient member or by the centre of gravity laying centre to the horizontal pivot axis and away from the centrifugal coffee brewing device.

### Safety Switch

In another aspect, the invention provides a centrifugal coffee brewing device, comprising:
a residue tray compartment for accommodating a residue tray,
a removable residue tray for holding coffee residue, wherein the residue tray is movable between an operational position inside the residue tray compartment and a removed position,
at least one biased switch being connected to a main drive and to a control unit and being switchable between a deactivated state and an activated state, wherein the switch is biased to be in the deactivated state,
wherein the placement of the residue tray in the operational position brings the at least one biased switch into the activated state, creating a closed circuit for the power supply and the main drive, allowing the activation of the drive and sending a signal to the control unit that the residue tray is in place, and
wherein the removal of the residue tray brings the at least one biased switch into the deactivated state, creating a short-circuit for the main drive and sending a signal to the control unit that the residue tray is not in place, the short-circuiting of the main drive causing the main drive to act as a brake for one or more components.

It was recognized by the applicant that the use of rapidly rotating components in a household appliance necessitates a safety mechanism. The abovementioned centrifugal coffee brewing device provides such a safety mechanism.

In one embodiment, the centrifugal coffee brewing device comprises two (biased) switches. A first biased switch is connected to the main drive and a second (biased) switch is connected to the control unit.

Regarding the placement, the first and second switch may be placed one above the other.

In one embodiment, the tray physically engages the at least one biased switch.

The residue tray may comprise a protrusion that protrudes from a side wall of the residue tray, this protrusion being configured to abut against the at least one biased switch when the residue tray is in the operational position.

In one embodiment, the residue tray compartment is defined by a wall having a protrusion opening. Herein, the opening is configured to allow the protrusion to extend through the protrusion opening. In this configuration, at least one biased switch is located opposite the opening.

In another embodiment, the residue tray compartment is defined by a wall comprising a flexible area. The flexible area being configured to be elastically deformed by the protrusion. In this configuration, at least one biased switch is located opposite the flexible are.

The protrusion that protrudes from the side wall of the residue tray may be located, when seen in top view, on the rear half of the residue tray.

The protrusion may also be located on the lower half of the residue tray, in particular on the lower 20 percent of the tray.

In another embodiment, the residue tray compartment is defined by a wall having a switch opening configured to allow at least one biased switch to protrude through the wall into the tray compartment. In an embodiment, at least one biased switch may comprise a switch protrusion.

In another embodiment, the residue tray compartment is defined by a wall comprising a flexible area configured to be elastically deformed by at least one switch. Herein, at least one biased switch deforms the flexible area into the residue tray compartment when the residue tray has been removed.

In yet another embodiment, the residue tray comprises a magnet that engages at least one biased switch, wherein the magnet is located close enough to the at least one biased switch to engage at least one biased switch when the residue tray is in the operational position.

In operation, the method for brewing coffee using a centrifugal coffee brewing device comprises the following steps:
a) placing a residue tray in a residue tray compartment into an operational position,
b) brewing a coffee beverage using the centrifugal coffee brewing device, wherein coffee residue is expelled after the coffee beverage has been extracted and is guided into the residue tray,
c) removing the residue tray from the operational position,
   wherein the placement of the residue tray in the operational position activates the at least one biased switch, creating a closed circuit for a power supply and a main drive, allowing the activation of the main drive and sending a signal to the control unit that the residue tray is in the operational position, and
   wherein the removal of the residue tray deactivates the at least one biased switch, creating a short-circuit for the main drive and sending a signal to the control unit that the residue tray is not in place, the short-circuiting of the main drive causing the main drive to act as a brake for one or more components.

The respective removal of placement of the residue tray physically engages or disengages the one or more switches.

### BRIEF DESCRIPTION OF THE FIGURES

FIG. 1 shows an isometric overview of the outside of one embodiment of the invention.

FIG. 2 shows an isometric overview of the inner workings of one embodiment of the invention.

FIG. 3 shows a cross-section of one embodiment of the invention wherein the filter is in the expulsion position.

FIG. 4 shows a cross-section of one embodiment of the invention wherein the filter is in the brewing position.

FIGS. 5A, 5B, 5C, and 5D show various embodiments of the direct water injection nozzle.

FIGS. 6A, 6B, 6C, and 6D show another embodiment of the direct water injection nozzle.

FIGS. 7A, 7B, and 7C show the placement of the direct water injection nozzle and the bottom wall for one embodiment of the invention.

FIGS. 8A,8B, and 8C show two embodiments of the direct water injection nozzle and the associated flow paths.

FIGS. 9A and 9B show a side view of an embodiment of the invention and a cross section of the corresponding skirt.

FIG. 10 shows a cross section as seen from the side of an embodiment of the invention.

FIGS. 11A and 11B show the rear side of one embodiment of the invention.

FIGS. 12A and 12B show an embodiment of the invention without the removable tank.

FIGS. 13A, 13B, 13C, and 13D show cross-sections of the rear of an embodiment of the invention.

FIGS. 14A, 14B, 14C, and 14D show an embodiment of a water filter.

FIGS. 15A, 15B, and 15C show different views of an embodiment of the residue tray.

FIGS. 16A, 16B, and 16C show the placement of an embodiment of the residue tray inside the residue tray compartment of an embodiment of the invention.

FIG. 17 shows a cross-section of the invention.

FIG. 18 shows a centrifugal coffee brewer according to the prior art.

FIG. 19 shows an enlarged view of a part of FIG. 18.

### DETAILED DESCRIPTION OF THE FIGURES

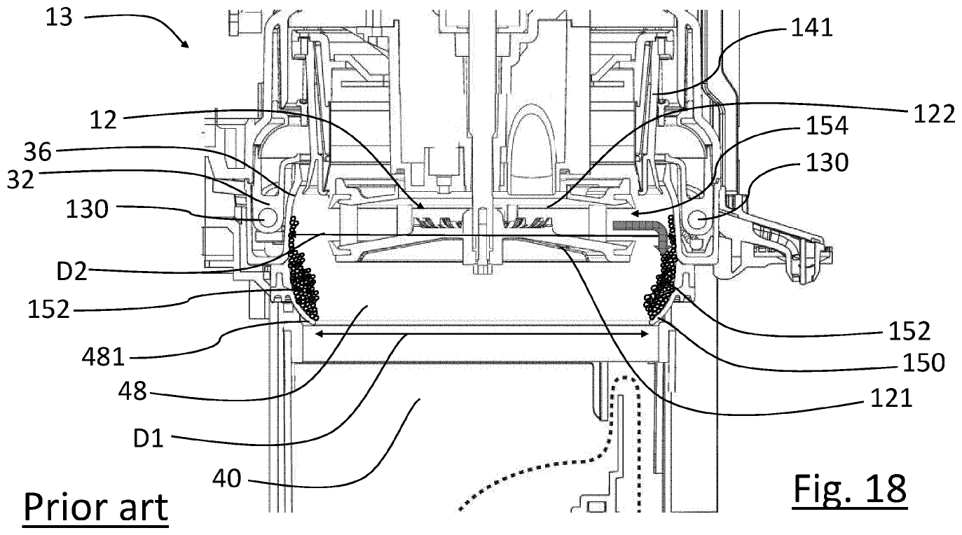

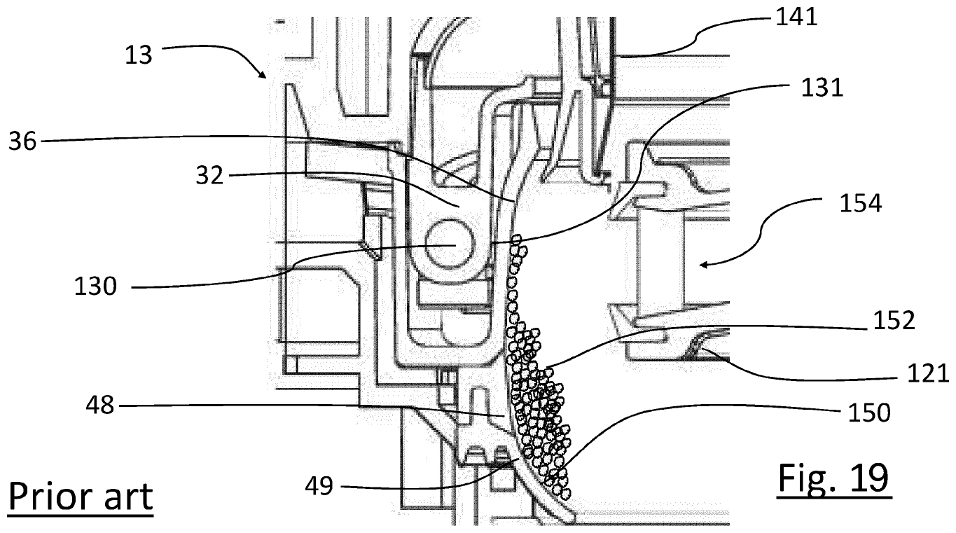

Turning to FIGS. 18 and 19, a centrifugal coffee brewer according to the prior art is shown. This centrifugal coffee brewer is disclosed in FIG. 32 of WO2019031964A1 (D1). The centrifugal coffee brewer has a brewing unit 13 which comprises a chamber element 12. The chamber element comprises a bottom wall 121 and a roof portion 122. A filter 141 is provided which can be moved between a lower position in which coffee can be brewed and an upper position in which the circumference of the chamber element 12 is open, i.e. has an opening 154. The open circumference allows coffee residue to be ejected though the opening 154. The filter 141 is shown in the upper position.

Around the chamber element 12, a residue deflection member 36 is provided. When the coffee residue is ejected the coffee residue impacts upon the residue deflection member 36. The residue deflection member is configured to direct the ejected coffee residue from the centrifugal brewing unit downwards as indicated by the arrow. The coffee residue is further guided by a skirt 48 and drops into the residue tray 40. The skirt 48 and its lower edge 481 can be seen on the lower side of the brewing unit 13. The outside of the gutter element 32 can also be distinguished.

A lower part of the skirt 48 is constricted and has a smaller diameter D1 than the diameter D2 of the residue deflection member 36. An inner surface 150 of the lower part 49 of skirt 48 faces slightly upwards. It was found that coffee residue 152 collects on this inner surface. This coffee residue tends to clog up the machine and forms a problem for the proper functioning of the coffee brewer. The coffee residue 152 not only sticks to the skirt, but also to the residue deflection member, albeit to a lesser extent.

Turning to FIG. 19 a gutter heater 130 is provided with the gutter element. The gutter heater heats the coffee which is ejected from the brewing chamber. The gutter element is separated from the residue deflection member 36 by an air gap 131. The air gap 131 is provided as thermal insulation. The air gap 131 ensures that all heat from the gutter heater 130 goes to the gutter and is not diverted to any other part and in particular not diverted to the residue deflection member 36. In use the residue deflection member 36 and the skirt stay relatively cold.

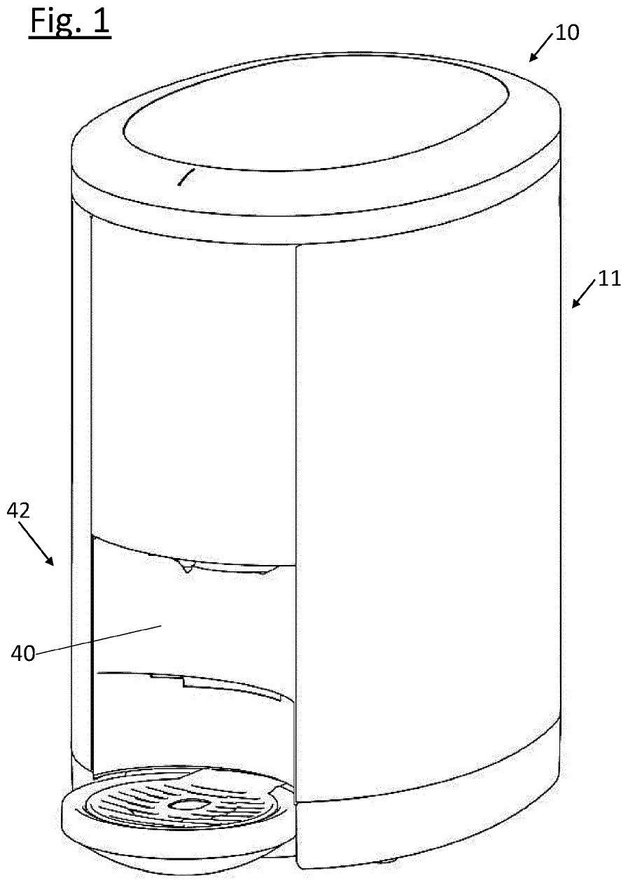

Turning to FIG. 1 a view of the outer housing 11 of one embodiment of the centrifugal coffee brewing device 10 is shown. The residue tray 40 has been placed inside the housing through the tray opening 42.

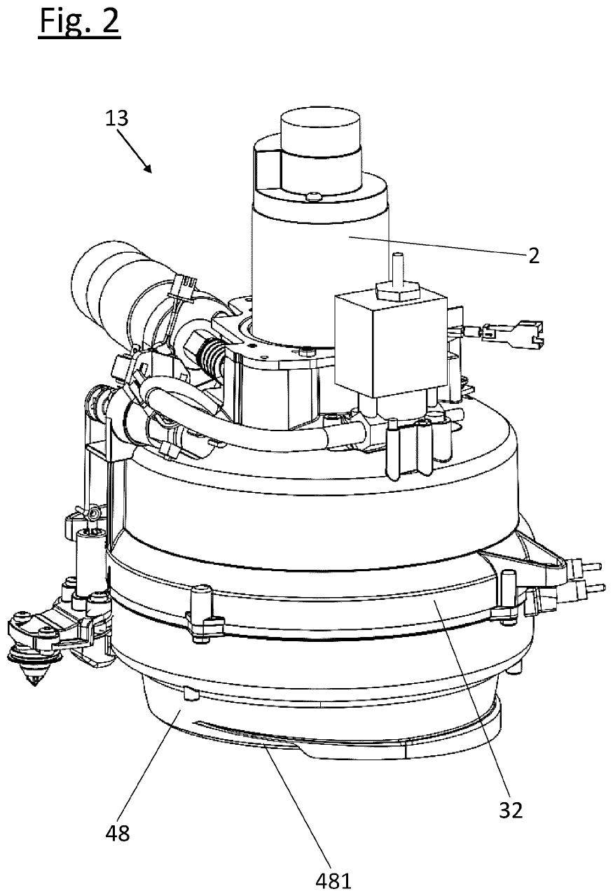

FIG. 2 shows a view of the inner workings of the centrifugal coffee brewing device. In the depicted view, the skirt 48 and its lower edge 481 can be seen on the lower side of the brewing unit 13. The outside of the gutter element 32 can also be distinguished.

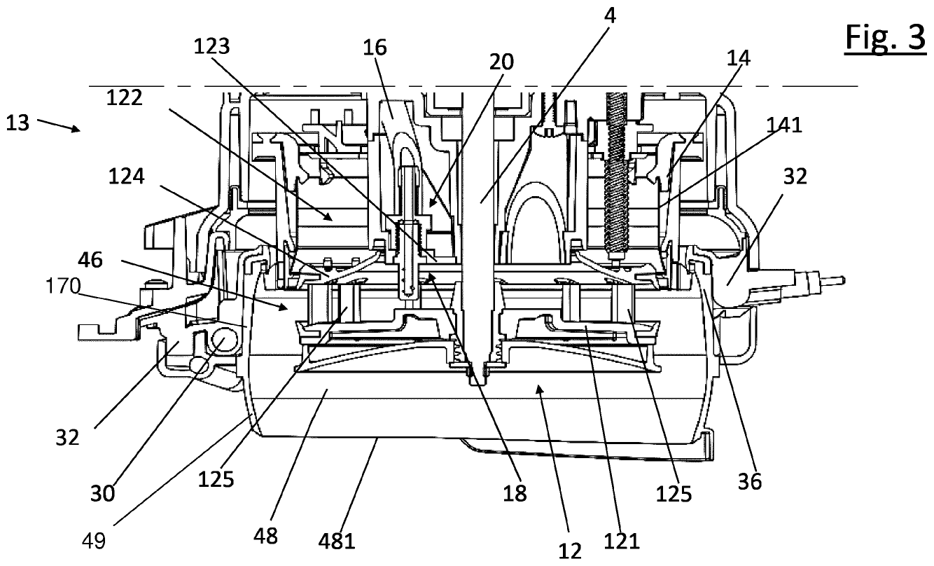

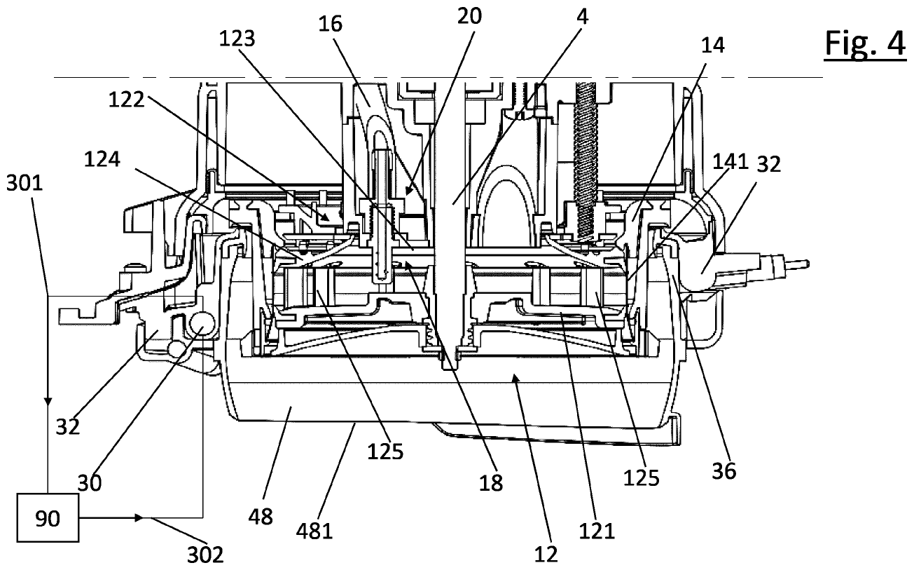

Turning to FIG. 3 and FIG. 4, cross-sections of the inner workings of one embodiment of the device are shown.

In FIG. 3, the device is in a state where coffee residue can be expelled from the centrifugal brewing unit 13. The coffee residue can be expelled via the coffee residue outlet 46 because the cylinder element 14 of the chamber element is at an upper location.

The centrifugal brewing unit 13 comprises the chamber element 12 comprising a bottom wall 121 and a roof portion 122. The roof portion 122 is divided into a stationary roof part 123 and a rotary roof part 124. The stationary roof part 123 defines a water inlet hole 18 through which at least a portion of the direct water injection nozzle 20 protrudes into the chamber element 12. Additionally, an inlet channel 16 is shown extending towards the water inlet hole from outside the chamber element. This inlet channel 16 is connected to the direct water injection nozzle 20. The inlet channel 16 and the direct water injection nozzle 20 are configured to inject water into the centrifugal brewing unit. The injected water is used to wetten a coffee bed that has formed over the filter 141. Herein, the direct water injection nozzle 20 is configured to spray water over a horizontal distance and to distribute water over the height of the coffee bed. At least a portion of the injected water is directly sprayed on the coffee bed.

Around the chamber element 12, a residue deflection member 36 is provided. This residue deflection member is configured to direct the ejected coffee from the centrifugal brewing unit towards a skirt 48. The residue deflection member 36 forms an inwardly facing wall which faces inwards and downwards. The skirt 48 is positioned below the residue deflection member and extends downward from the residue deflection member. The skirt extends to a position below the bottom wall 121 of the chamber element. The skirt 48 is configured to further guide the coffee residue into the residue tray 40.

A heater element 30 is provided wherein the heater element heats the skirt. The skirt is heated to a temperature of at least 50 degrees Celsius by the heater element. The heating of the skirt prevents condensation of moisture inside the centrifugal coffee brewing device on the skirt.
A lower part 49 of the skirt is constricted. The constricted lower part 49 faces upward.

The residue deflection member and the skirt are integrated and together form a single ring-shaped residue guiding component 170. The entire residue guiding component is heated by the heater element. The residue deflection member and the skirt are manufactured from a heat conducting material, preferably metal, more preferably aluminium.

The heater element 30 may be integrated with the skirt 48 or in contact with the skirt and may directly heat the skirt 48. Alternatively or additionally the heater element may be integrated with the residue deflection member 36 or be in contact with the residue deflection member. In this case the heater element 30 indirectly heats the skirt via conduction of heat through the residue deflection member to the skirt.

The heater element 30 also heats the residue deflection member 36. In use the residue deflection member is also heated to a temperature of at least 50 degrees Celsius by the heater element. The heating of the residue deflection member prevents condensation of moisture inside the centrifugal coffee brewing device on the residue deflection member, thereby reducing sticking of expelled coffee residue to the residue deflection member.

The centrifugal coffee further comprises a gutter element 32 which defines a gutter located around the centrifugal brewing unit, via which brewed coffee travels to a coffee outlet 34. The gutter and the residue deflection member may be integrated into one component. Alternatively, the residue deflection member and the gutter may be separate elements which are in contact with one another in order to allow heat to transfer between the residue deflection member and the gutter. This is the embodiment shown in FIG. 3. The heater element 30 is part of the gutter and is configured to also heat the gutter.

The heater element 30 may directly or indirectly heat the skirt.

The residue deflection member may be coated with a non-sticking material. It may be coated with polytetrafluoroethylene, more in particular with Teflon. In this embodiment, a gutter element 32 is also heated by the heater element 30.

In this embodiment, the heater element 30 is shown in a location under the gutter. In particular, the heater element 30 is integrated in the gutter element 32, and the residue deflection member 36 is in thermal contact with the gutter.

In another embodiment, the gutter element 32 and the residue deflection member 36 may also be integrated into one component.

The bottom wall 121 comprises columns 125 that extend upwardly towards the roof portion of the centrifugal brewing unit. When the cylinder element 14 is at an upper location, the rotation of the chamber element 12, and therewith the bottom wall 121 comprising columns, may act as a blower. The columns 125 may push the air around, forcing hot air heated by the heater element 30 into the residue tray and drying the residue impact wall and the residue tray. The columns 125 work as an impeller.

FIG. 4 shows the same embodiment of the invention with the cylinder element 14 in a lower position. This configuration is the coffee brewing configuration wherein the direct water injection nozzle 20 injects water into the chamber element 12. The water then reaches a coffee bed that has formed over the cylinder element 14.

During operation, a motor 2 rotates a shaft 4 that is connected to the centrifugal brewing unit. By rapidly rotating the coffee bed that has formed over the filter 141 of the cylinder element 14, the coffee beverage is extracted.

The coffee is then directed into the gutter 32 which is heated by the heater element 30 and flows towards a coffee outlet. The heater element 30 is controlled by a control unit 90 that has an input line 301 and has an output line 302.

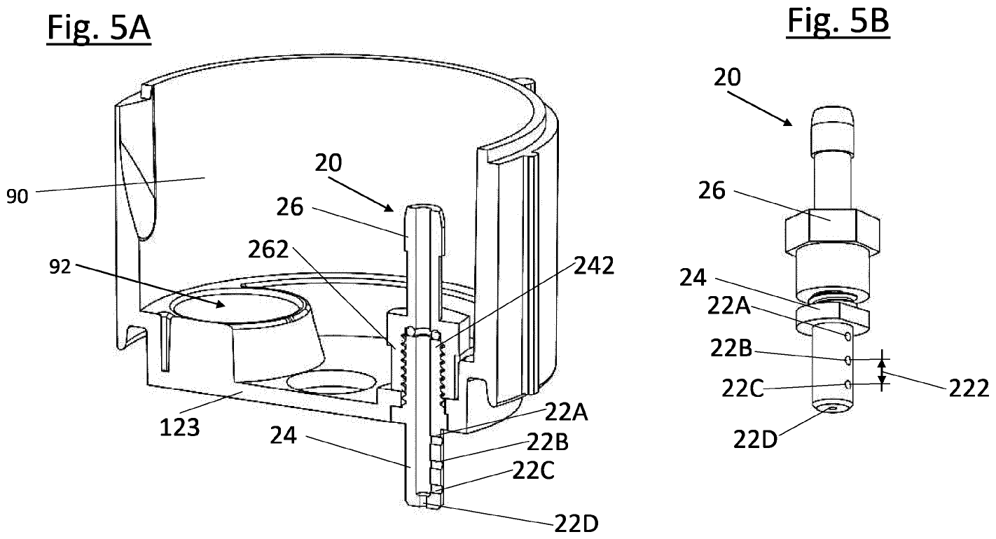

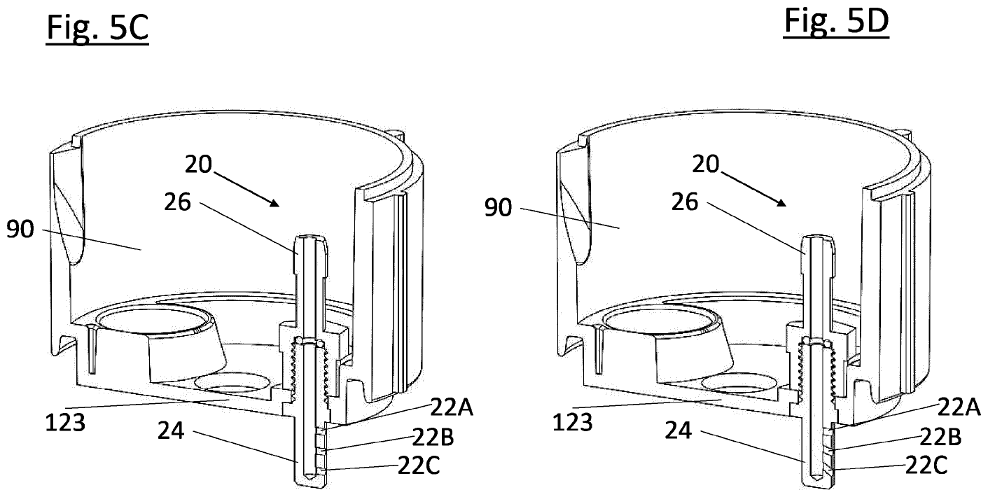

Turning to FIGS. 5A and 5B, a first embodiment of the direct water injection nozzle 20 is shown. FIG. 5A shows the direct water injection nozzle 20 being connected to the stationary roof part 123 of the chamber element. FIG. 5B shows the same direct water injection nozzle 20 standing alone.

The depicted embodiment is shown comprising a coupling portion 26 that is configured to be coupled to the inlet channel 16 of the centrifugal coffee brewing device. This connection is located outside the chamber element. The coupling portion is also coupled to the nozzle portion 24 of the direct water injection nozzle 20 via the coupling means comprising the outer thread 242 on the nozzle portion 24 and the inner thread 262 on the coupling portion 26.

The connection between the coupling portion 26 and the inlet channel 16 could also be located inside the chamber element 12, i.e. below the stationary roof part 123.

In this embodiment, the direct water injection nozzle 20 comprises four nozzle outlets 22A, 22B, 22C, and 22D. One nozzle outlet 22D is direct substantially downwards towards the bottom wall. All four nozzle outlets 22A, 22B, 22C, and 22D are oriented in the same plane and the nozzle outlets 22A, 22B, and 22C are oriented substantially parallel to each other. In this embodiment, all nozzle outlets 22A, 22B, 22C, 22D are spaced apart over a vertical distance 222.

In this embodiment, the stationary root part defines a ground coffee inlet hole 92 and comprises an upwardly extending skirt 90.

FIGS. 5C and 5D show two further embodiments of the nozzle portion 24 of the direct water injection nozzle 20.

FIG. 5C depicts an embodiment wherein the nozzle portion 24 comprises three nozzle outlets 22A, 22B, and 22C. These are oriented substantially parallel to each other and are oriented in the same plane and are spaced apart over a vertical distance.

FIG. 5D depicts an embodiment wherein the nozzle portion 24 comprises three nozzle outlets 22A, 22B, and 22C that are oriented at an angle between 0 and 90 degrees with respect to each other. The nozzle outlets 22A, 22B, and 22C are oriented in the same plane.

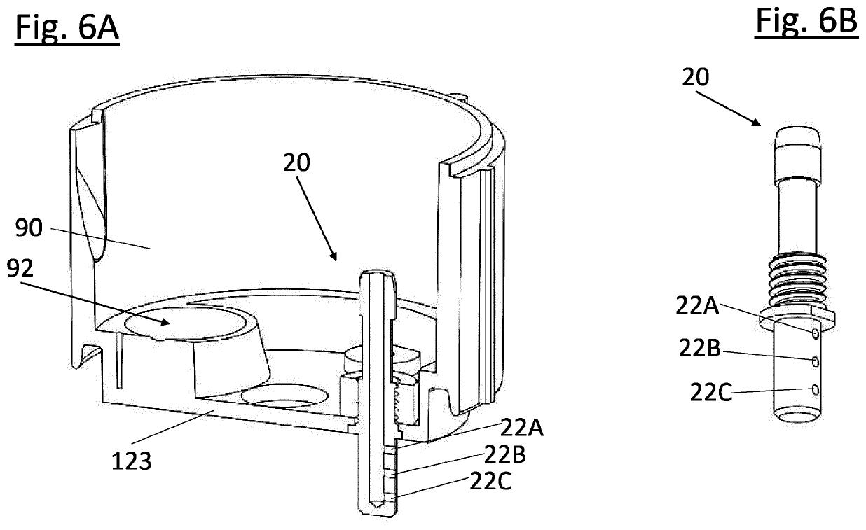

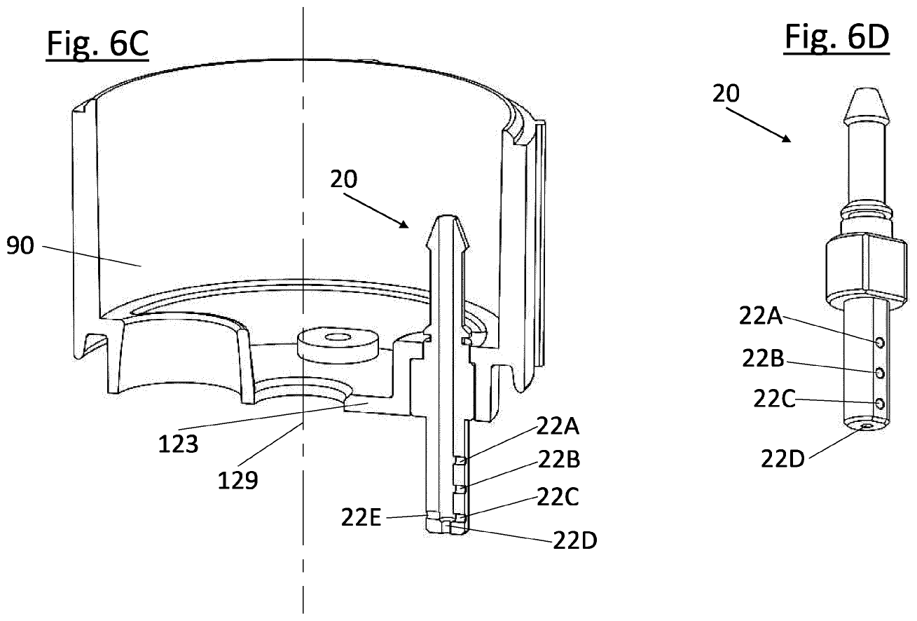

FIGS. 6A,6B, 6C, and 6D depict other embodiments wherein the direct water injection nozzle 20 comprises a single portion comprising the nozzle outlets and the means to be coupled to the inlet channel 16.

FIG. 6A shows the direct water injection nozzle being connected to the stationary roof part 123 of the chamber element 12. FIG. 6B shows the direct water injection nozzle 20 as standing alone. In this embodiment, the direct water injection nozzle 20 is connected to the stationary roof part 123 via threading, wherein the direct water injection nozzle comprises outer threading and the stationary roof part comprises inner thread.

FIG. 6C shows the direct water injection nozzle 20 being connected to the stationary roof part 121 of the chamber element 12. FIG. 6D shows the direct water injection nozzle as standing alone. In this embodiment, the direct water injection nozzle 20 is connected to the stationary roof part 123 via a snap-fit. Such a connection can make it relatively simple to remove and install the direct water injection nozzle; this is beneficial to the ease of use.

The direct water injection nozzle 20 depicted in FIG. 6C comprises multiple nozzle outlets 22A, 22B, 22C, 22D, 22E. Three nozzle outlets 22A, 22B, and 22C are oriented at an angle between 0 and 90 degrees with respect to each other, in particular they are parallel. The nozzle outlet 22D is oriented towards the bottom wall 121 and the nozzle outlet 22E is oriented towards the centre-axis 129 of the bottom wall, both being configured to, at least partially, clean the bottom wall. In this embodiment, the nozzles 22C, 22D, and 22E are oriented at an angle of 90 degrees with respect to each other.

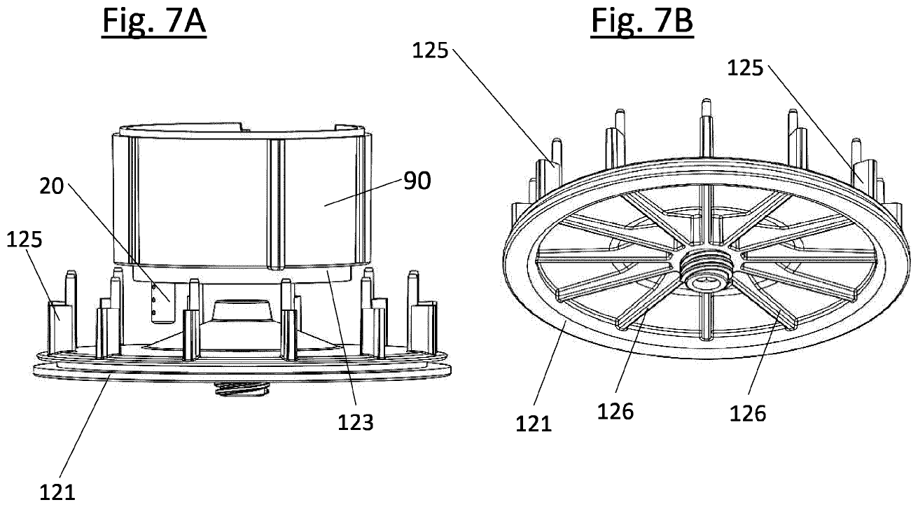

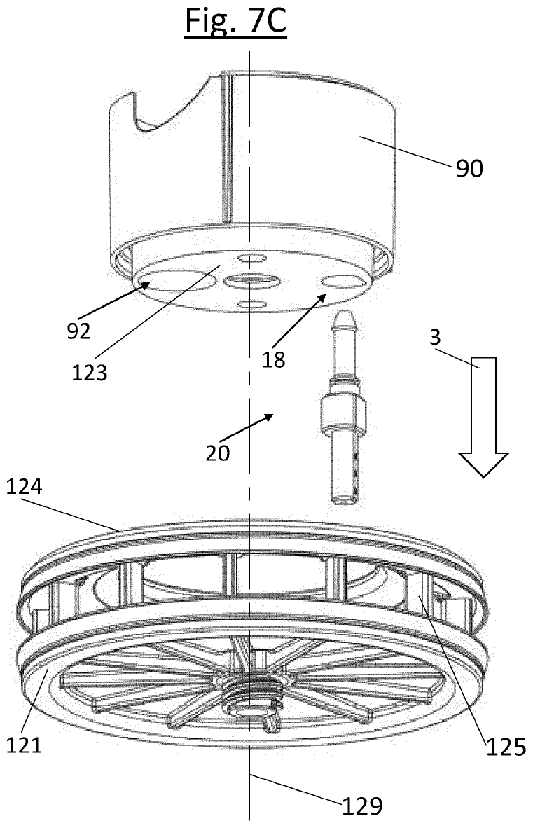

FIG. 7A shows a side view of the chamber element 12 without the cylinder element 14 and the rotary roof part 124. The stationary roof part 123 is depicted with the direct water injection nozzle 20 protruding downwards. The bottom wall 121 is located below the stationary roof part 123 and the direct water injection nozzle 20. FIG. 7B depicts a bottom view of the bottom wall 121 showing that the underside is hollow and that the bottom wall comprises protrusions 126 extending downwards.

FIG. 7C shows an exploded view of the stationary roof part 123, the direct water injection nozzle 20, and the chamber element comprising a bottom wall 121 and a rotary roof part 124. It is in a direction 3 that, for maintenance purposes, the device may be dissembled. First the chamber element is removed downwards, after which the direct water injection nozzle 20 may be disconnected from the stationary roof part 123. Such an easy process may be carried out by a repairman, but in an embodiment, also by a regular consumer. Herein, the stationary roof part is considered to be the fixed world.

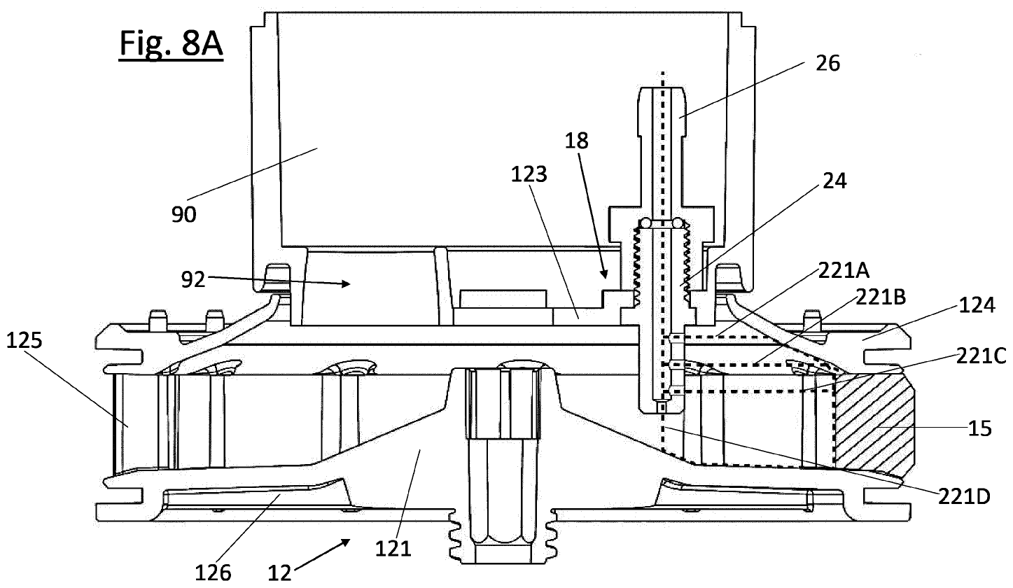

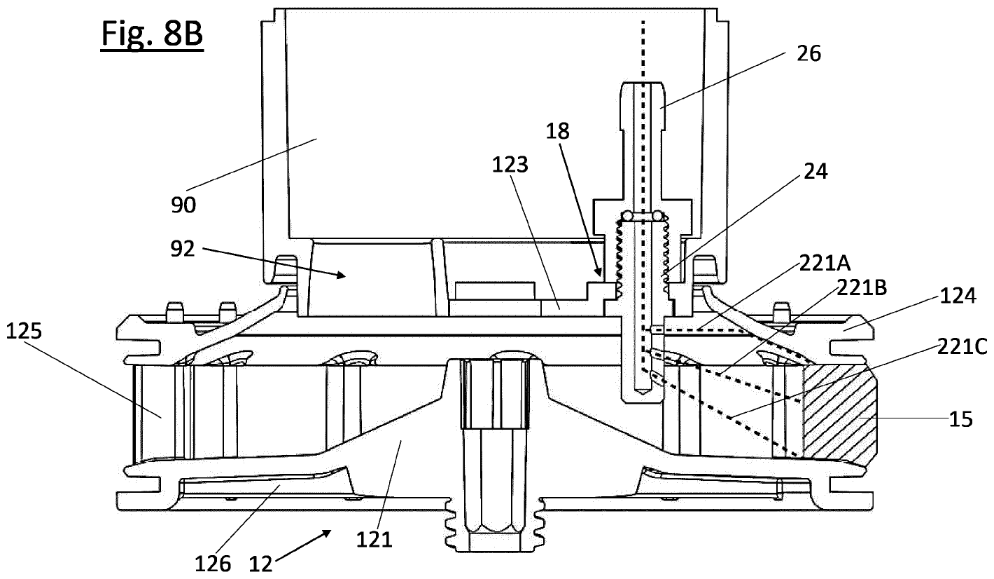

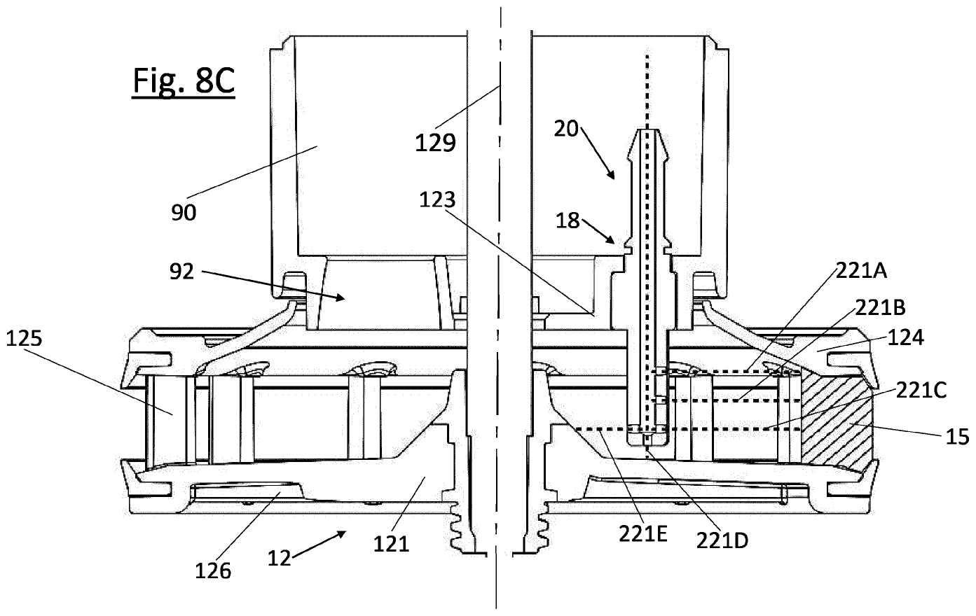

FIG. 8A shows possible paths 221A, 221B, 221C, 221D along which the injected water can be sprayed from the direct water injection nozzle 20 onto the coffee bed 15.

FIG. 8A shows the embodiment of the direct water injection nozzle 20 depicted in FIG. 5A wherein the nozzle portion 24 comprises four nozzle outlets 22A, 22B, 22C and 22D with the respectively corresponding flow paths 221A, 221B, 221C, and 221D. In practice, the flow paths of the injected water will diverge somewhat from the depicted paths due to the differences between the depicted, ideal situation and the real world, non-ideal situation.

In this embodiment, the two upper flow paths 221A, 221B first reach the rotary roof part 124 before being guided towards the coffee bed 15. The flow path 221C directly reaches the coffee bed 15. The flow path 221D comes out of the downwardly directed nozzle outlet 22D and directly injects water against the bottom wall 121 before being directed towards the coffee bed 15.

Turning to FIG. 8B shows the embodiment of the direction water injection nozzle 20 shown in FIG. 5D. In this embodiment, the nozzle portion 24 comprises three nozzle outlets 22A, 22B, 22C with the corresponding flow paths 221A, 221B, 221C.

Herein, the upper flow path 221A first reaches the rotary roof part 124 before being directed towards the coffee bed 15. The two lower flow paths are directly injected upon the coffee bed 15.

FIG. 8C shows the embodiment of the direction water injection nozzle 20 shown in FIG. 6C. In this embodiment, the direct water injection nozzle 20 comprises both the coupling portion and nozzle outlets 22A, 22B, 22C, 22D, 22E with the corresponding flow paths 221A, 221B, 221C, 221D, 221E. Herein, the direct water injection nozzle 20 protrudes from within the chamber element through the water inlet hole 18 formed by the stationary roof part 123.

Flow paths 221A, 221B, 221C all directly reach the coffee bed 15 in order to evenly wetten it. Flow paths 221D and 221E directly reach the bottom wall 121, wherein the flow path 221D is directed substantially downward and the flow path 221E is direct towards the centre-axis of the bottom wall.

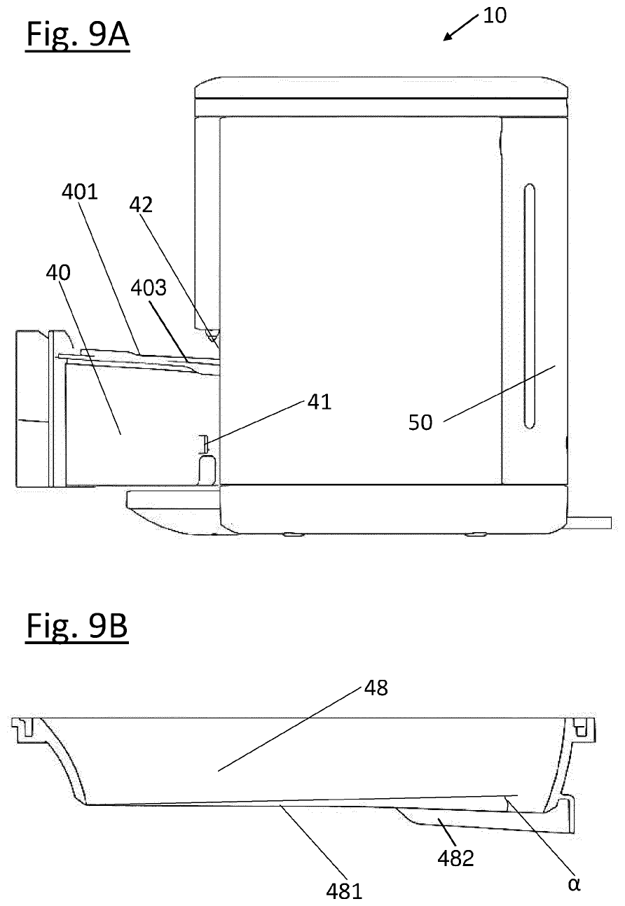

In FIG. 9A, an embodiment of the centrifugal coffee brewing device 10 is shown with the residue tray 40 outside of the residue tray compartment being partially placed in the tray opening 42 of the housing. A removable water tank 50 is positioned on the backside of the centrifugal coffee brewing device. Additionally, a protrusion 41 on the residue tray 40 is shown.

Turning to FIG. 9B, the skirt 48 that is connected to the coffee residue outlet and is located below the residue deflection member 36 is depicted alone. The slanted lower edge 481 of the skirt is configured to mate and to form a tight fitting closure with the slanted upper edge 401 of the residue tray 40 that is depicted in FIG. 9A when the residue tray is in the operational position 402. To this end, a part 482 of the skirt may be manufactured out of a flexible material. Similarly, a part 403 of the residue tray may also be manufactured out of a flexible material. Herein, the operational position is located below the skirt and at the end of a tray trajectory. The lower edge 481 of the skirt 48 and the upper edge 401 of the residue tray 40 may be lowest at an end of the tray trajectory. The slanted lower edge 481 of the skirt and the slanted upper edge 401 of the residue tray are slanted at an angle α with respect to the horizontal. In an embodiment the angle α lies between 1-2 degrees. The angle α may increase along both edges towards the lowest point.

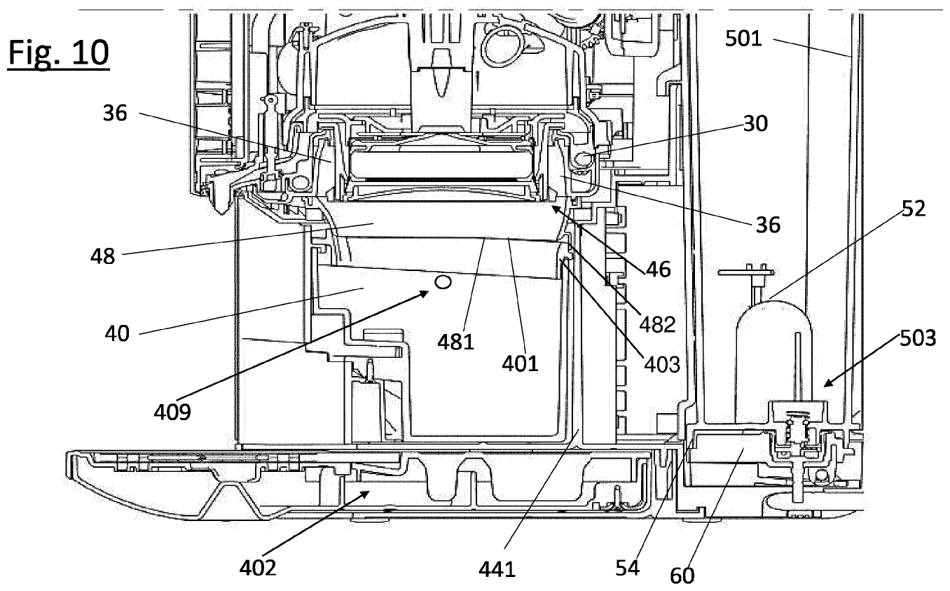

FIG. 10 shows a cross-section of the centrifugal coffee brewing device. In the cross-section, the residue tray 40 has been placed in the residue tray compartment 44 which is defined by the tray compartment wall 441, and is in the operational position 402. The upper edge 401 of the residue tray is shown engaging the lower edge 481 of the skirt 48. Here, a part of the skirt 48 is made from a flexible material to create a tight fit between the skirt 48 and the residue tray 40 in the operational position 402. The skirt 48 is shown to be located below the residue deflection member 36.

From the figure, it can be seen that coffee residue can be expelled from the coffee residue outlet 46 and is deflected by the residue deflection member 36 and the skirt 48 into the residue tray 40. The skirt is a constricted skirt 48 having a larger upper diameter than a lower diameter. Additionally, the lower diameter of the skirt 48 may be smaller than the upper diameter of the residue tray 40. This way, the coffee residue will be able to reach only the inside of the residue tray.

Either the residue tray 40 or the skirt 48 may also comprise a hole 449 for the prevention of mould.

In addition, on the right of the cross-section, being configured for holding a liquid, in particular water, the removable water tank 50 is shown. The removable tank comprises the wall 501 which defines an inner volume and comprises tank recesses 52 extending into the inner volume. On the lower end of the removable tank 50, the outlet 503 for discharging the liquid is depicted comprising a valve, the outlet 503 being located in between the tank recesses. Additionally, a lower end 54 of the tank is shown engaging the pivotable tank support platform 60.

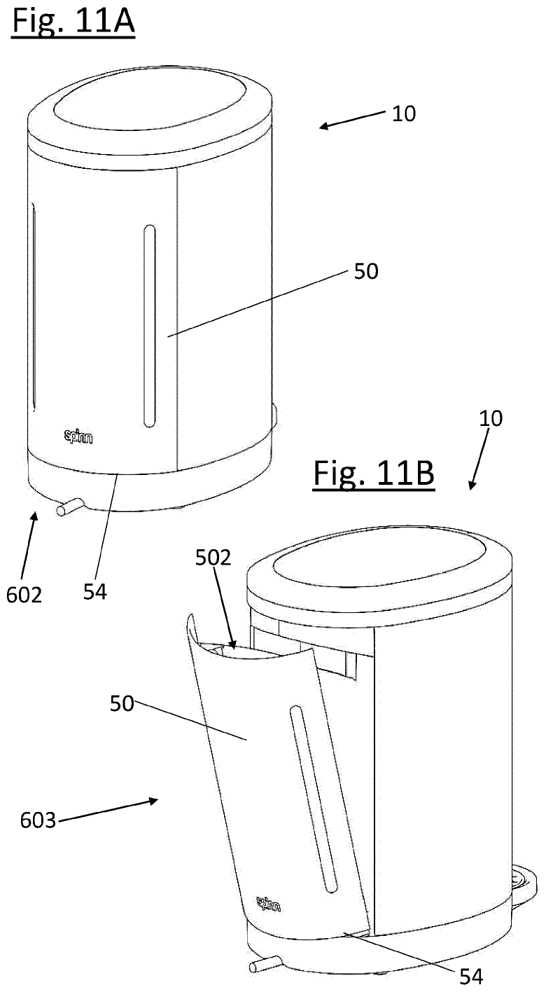

FIGS. 11A and 11B respectively show the operational position 602 and the inclined removal position 603 of the removable tank 50 being positioned on the centrifugal coffee brewing device 10. Herein, the pivotable tank support platform 60 is pivotable about a horizontal pivot axis between the operational position 602 and the inclined removal position 603.

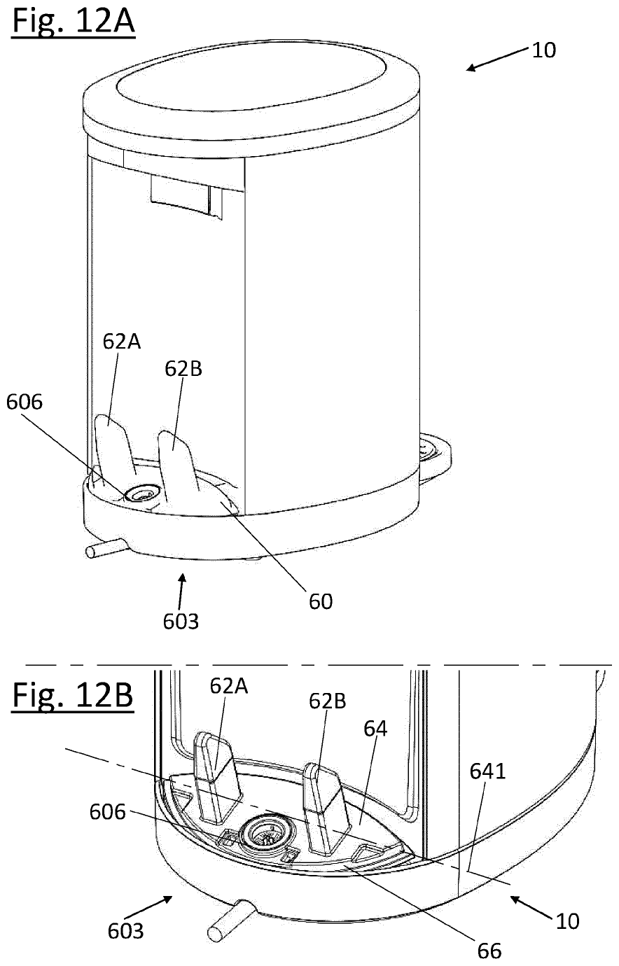

FIGS. 12A and 12B both show the rear side of the centrifugal coffee brewing device 10 without the removable tank 50. FIG. 12A shows an overview and FIG. 12B shows a close-up of the pivotable tank support platform 60.

The pivotable tank support platform of FIG. 12B comprises two platform protrusions 62A, 62B and is depicted in the removal position 603. The protrusion protrude upwardly from a central portion 64. In this embodiment, the pivotable tank support platform 60 comprises the inlet 606 which is located between the platform protrusions 62. During the placement of the tank 50, the outlet 503 is coupled to the inlet 606. The pivotable tank support platform also comprises a central portion 64 and a circumferential portion 66, wherein the lower end 54 of the removable tank 50 is configured to be coupled to and uncoupled from the pivotable tank support platform 60, in particular to and from the circumferential portion 66. The pivotable tank support platform is configured to pivot about a horizontal pivot axis 641.

In FIG. 12B, it can be seen that both platform protrusions, whose length is more than three times larger than their width, comprise a tapered end configured to facilitate the guidance of the removable tank 50 onto the platform protrusions 62 in the inclined removal position 603. The top of each platform protrusion 52 has an asymmetrically bevelled top, configured to align and centre the tank recesses 52. Herein, the platform protrusion 62A, 62B form register pins and the tank recesses 52A, 52B form register holes for keeping the water tank in the required position. The platform protrusions 62 are spaced at a distance and the protrusions are spaced at a similar distance.

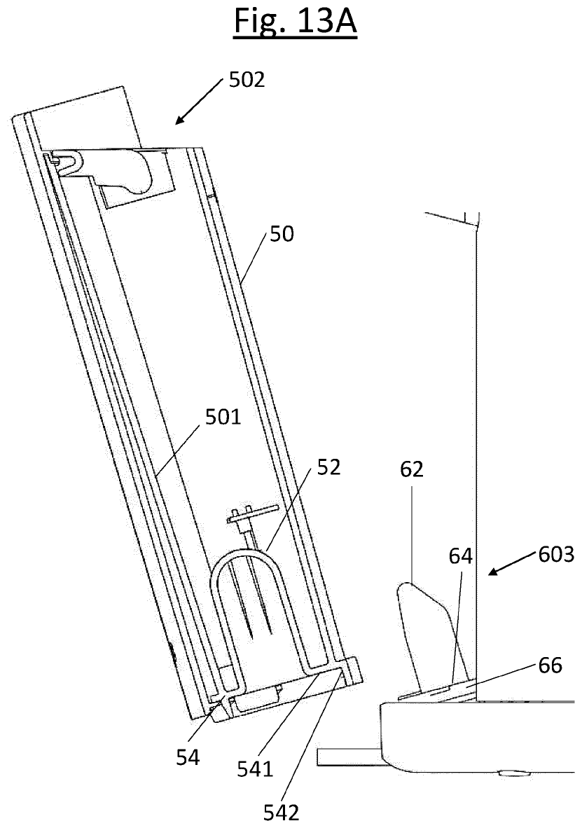

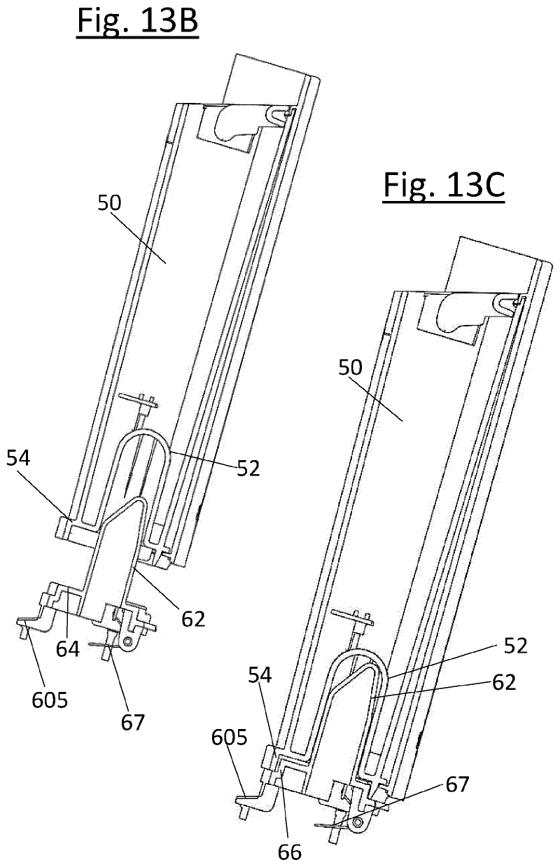

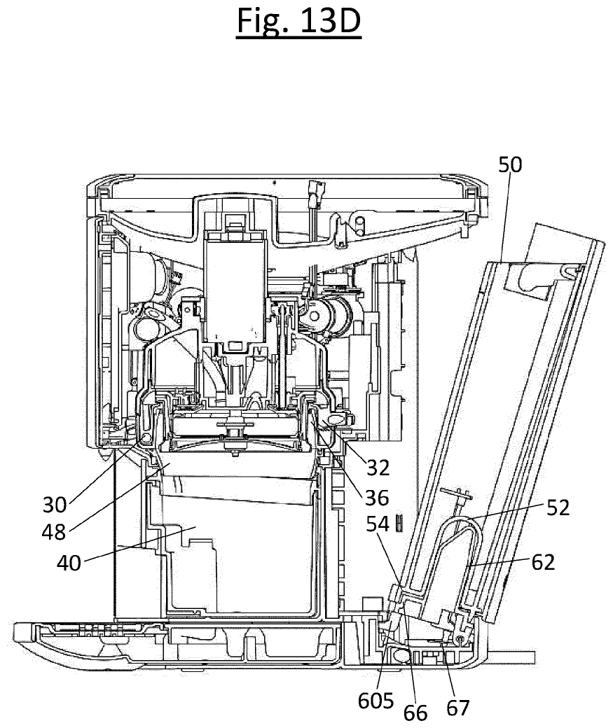

Turning to FIG. 13, the combination of the removable tank 50 and the pivotable tank support platform is shown in various stages.

In FIG. 13A, a cross-section of the removable tank 50 is shown apart from the pivotable tank support platform 60. The removable tank comprises a wall 501 and an opening 502 for the filling of the tank. By placing the tank recess 52 over the platform protrusion 62 while the pivotable tank support platform is in the removal position 603, the removable tank 50 is guided towards the pivotable tank support platform 60.

The lower end 54 of the tank 50 comprises a skirt 542 which extends circumferentially downwards and a lower wall 541, and the pivotable support platform 60 comprises a central portion 64 and a circumferential portion 66, the central portion being raised relative to the circumferential portion, wherein in the operation position the skirt engages the circumferential portion and the lower wall 541 abuts against the central portion 64

The lower end 54 of the tank also forms a base on which the tank can stand.

This guiding is shown in FIGS. 13B and 13C a cross-section of the combination of removable tank 50 and pivotable tank support platform 60 is shown. In FIG. 13B, the resilient member 67 can be seen. This resilient member 67 is a spring and is biased to pivot the pivotable tank support platform 60 towards the removal position 603 until the rotational limiters 605 abut against the centrifugal coffee brewing device 10 when the tank has been removed.

In FIG. 13C, the tank recess 52 is shown to have the same inner dimensions as the outer dimensions of the platform protrusion 62, thereby creating a clearance fit. The lower end 54 engages the circumferential portion 66.

In FIG. 13D, the configuration shown in FIG. 13C is shown as being attached to the rest of the centrifugal coffee brewing device and is located at the rear side of the centrifugal coffee brewing device.

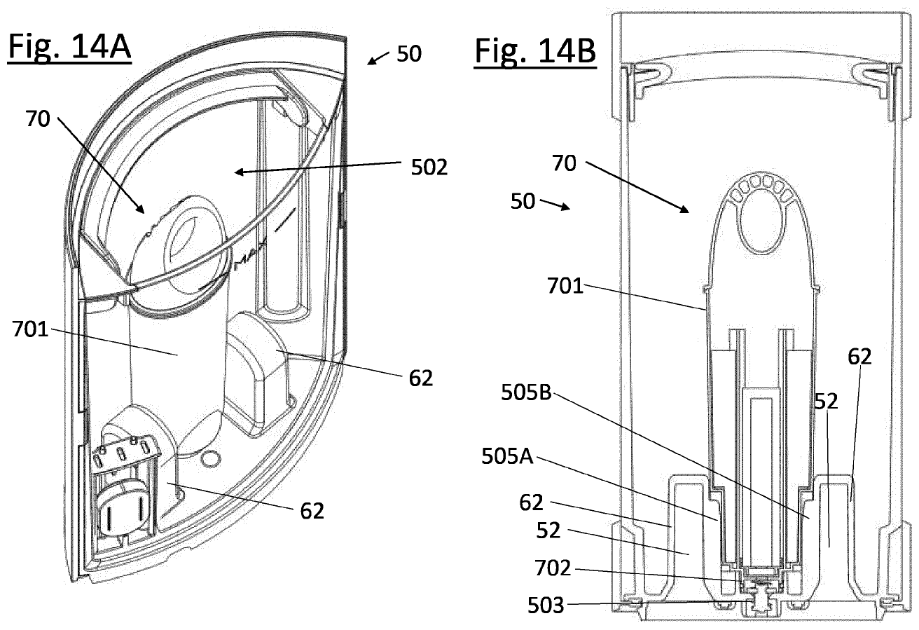

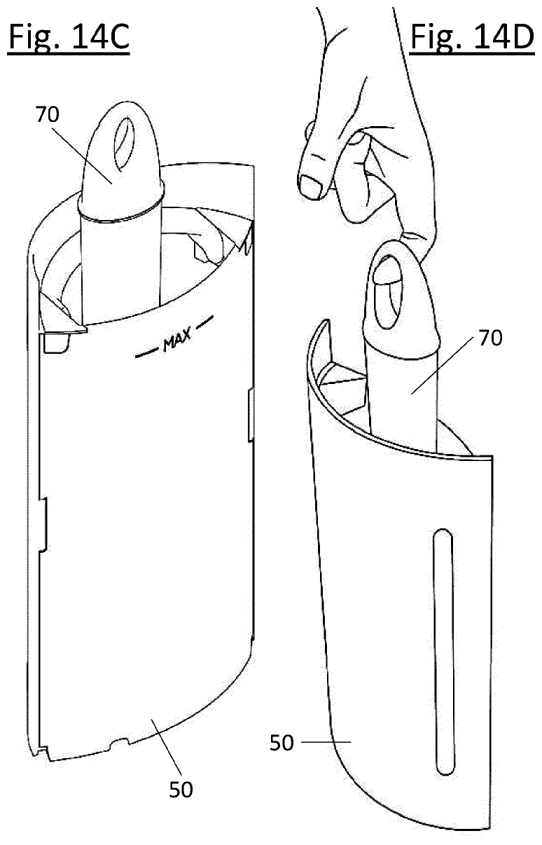

The removable tank 50 is also depicted in FIG. 14. In FIGS. 14A and 14B, the opening 502 for filling is also shown. The removable tank 50 is configured to accommodate a removable filter 70. This removable filter 70 is configured to engage the tank outlet 503, wherein the tank comprises a guide path defined by guide elements 505A, 505B for the removable filter 70. The guide path allowing the repeatable and accurate positioning of the removable filter onto the valve. The guide path is configured to guide the removable filter towards the valve from a position relatively far away.

The removable filter 70 is shown comprising a filter body 702 and an outlet 701 The inlet of the removable filter 70 is not depicted. The outlet 701 comprises means for engaging the valve of the removable tank 50.

When the removable filter 70 is placed in the removable tank 50, the outlet 701 is on open communication with the tank valve comprised in the tank outlet 503.

In FIGS. 14C and 14D the filter 70 is being placed in the removable tank 50. The hand shown in FIG. 14D illustrates the ease of use for the removal and installation of such a filter. The guide path along which the removable filter 70 is placed may be defined by at least one tank recess 52.

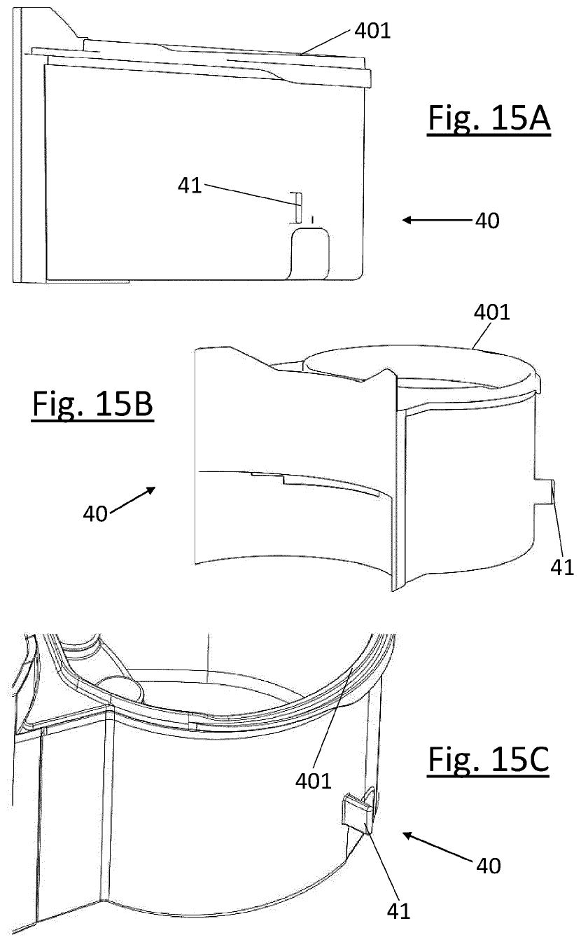

FIG. 15 shows three views of the same embodiment of the residue tray 40 comprising the upper edge 401 and a protrusion 41. In FIG. 15A, the protrusion 41 is located on the rear half of the residue tray 40. Additionally, it can be seen that the protrusion 41 is located on the lower half of the residue tray 40.

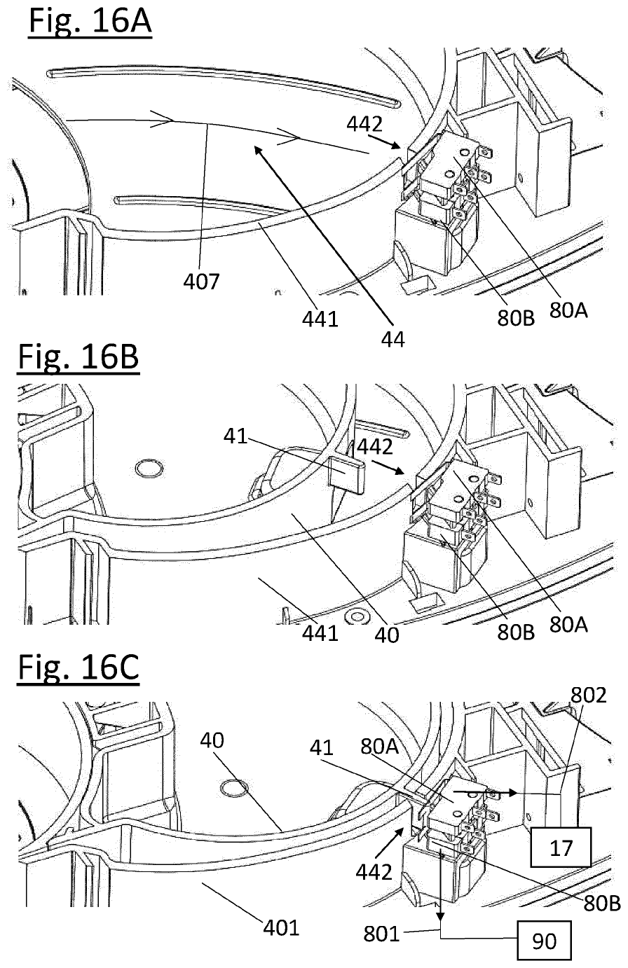

FIG. 16 shows the process of placing the residue tray 40 in the residue tray compartment 44.

Turning to FIG. 16A, the empty residue tray compartment 44 is shown together with its wall 441 and the protrusion opening 442. On the opposite side of the protrusion opening 442, two biased switched 80A, 80B are shown to be located one above the other. The protrusion 41 extends through the protrusion opening 442 when the residue tray 40 is in the operational position.

It may be understood that, instead of the protrusion opening 442, the tray compartment wall 441 may comprise a flexible area, wherein the protrusion 41 engages the switches by elastically deforming this area against the switches.

The skilled person will understand that it can also be the biased switches 80 that extend through the protrusion opening 442 or that the switches deform an flexible area of the tray compartment wall 441 into the residue tray compartment. And that the placement of the residue tray 40 in the operational position 402 engages the extending or protruding switches 80.

It will also be understood by the skilled person that a magnet attached to the residue tray can be used to engage the switches 80 while the wall does not comprise a flexible area or protrusion opening 442.

In FIG. 16B, the residue tray 40 is being introduced into the residue tray compartment 44.

Turning to FIG. 16C, the residue tray 40 has been placed into the operational position 402 and the protrusion 41 physically engages the two switches 80A, 80B. Here, the protrusion 41 abuts against the two biased switches 80A, 80B. The first switch 80A is connected 802 to the main drive and the second switch 80B is connected 801 to the control unit.

By disengaging a first switch 80A, the removal of the residue tray 40 short-circuits the main drive 17, causing it to act as a brake, and by disengaging a second switch 80B, the control unit 90 receives a signal that the residue tray 40 is not in the operational position 402.

By engaging a first switch 80A, the placement of the residue tray 40 closes the circuit from power supply to the main drive, and by engaging a second switch 80B, the control unit receives a signal that the residue tray 40 is in the operational position 402.

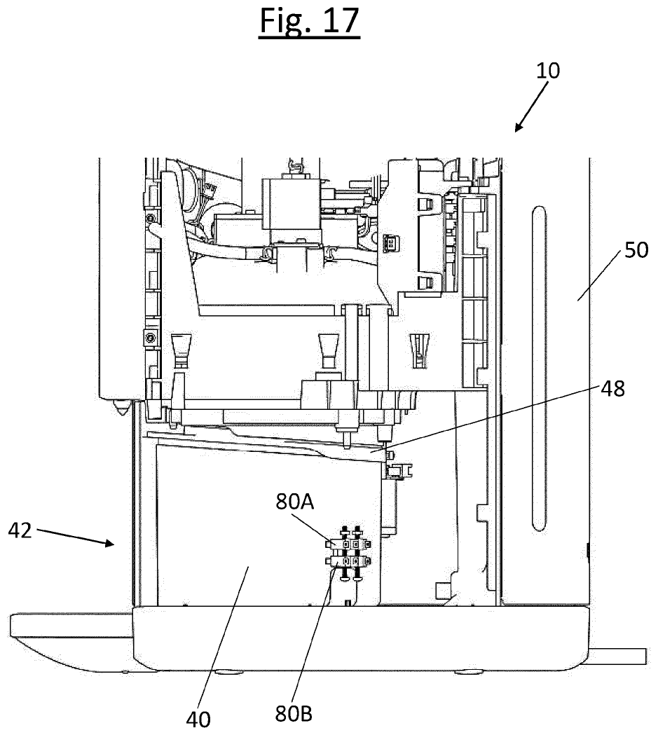

FIG. 17 shows a cross-section of the centrifugal coffee brewing device where the removable tank 50 is placed on the pivotable tank support platform 60, being in the operational position 602, and the residue tray 40 being placed in the operational position 402, engaging the two switches 80A, 80B. Herein, the upper edge 401 of the residue tray 40 engages the skirt 48.

The present disclosure relates to the following clauses:
1. Centrifugal coffee brewing device (10), comprising:
   a centrifugal brewing unit constructed to brew coffee, the centrifugal brewing unit comprising:
      a chamber element (12) comprising a bottom wall (121) and a roof portion (122),
      a cylinder element (14) comprising a filter
   a heater element (30),
   a gutter element (32) which defines a gutter located around the centrifugal brewing unit, via which brewed coffee travels to a coffee outlet (34),
   a residue deflection member (36) for guiding coffee residue which is ejected from the centrifugal brewing unit into a residue tray, wherein the residue deflection member is heated by the heater element.
2. Centrifugal coffee brewing device according to the previous clause, wherein the residue deflection member is coated with a non-sticking material.
3. Centrifugal coffee brewing device according to the previous clause, wherein the non-sticking material is polytetrafluoroethylene, more in particular Teflon.
4. Centrifugal coffee brewing device according to any of the preceding clauses, wherein the gutter element is also heated by the heater element.
5. Centrifugal coffee brewing device according to any of the preceding clauses, wherein the heater element is located under the gutter.
6. Centrifugal coffee brewing device according to any of the preceding clauses, wherein the gutter and the residue deflection member are integrated into one component.
7. Centrifugal coffee brewing device according to any of the preceding clauses, wherein the residue deflection member and gutter are separate elements which are in thermal contact with one another, wherein the heater element is part of the gutter.
8. Centrifugal coffee brewing device according to any of the preceding clauses, wherein the centrifugal coffee brewing device comprises a control unit (90) being configured to control at least the heater element, wherein the control unit turns on the heater element substantially simultaneous to when the centrifugal coffee brewing device is turned on.
9. Centrifugal coffee brewing device according to any of the preceding clauses, wherein the centrifugal coffee brewing device comprises a control unit being configured to control at least the heater element, wherein the control unit turns off the heater element substantially simultaneous to when the centrifugal coffee brewing device is turned off.
10. Centrifugal coffee brewing device according to any of clauses 1-8, wherein the centrifugal coffee brewing device comprises a control unit being configured to control at least the heater element, wherein the control unit turns off heater element less than 60 seconds after the centrifugal coffee brewing device has been turned off, in particular after 10-30 seconds, more in particular, after 20 seconds.
11. Centrifugal coffee brewing device according to any of the preceding clauses, wherein the heater element is placed at a distance smaller than 10 cm from the centrifugal brewing unit and/or from the residue tray and wherein the radiant heat of the heater element heats the centrifugal brewing unit and/or the residue tray.
12. Centrifugal coffee brewing device according to any of the preceding clauses, wherein the bottom wall comprises at least one column (125) that extends upwards towards the roof portion of the chamber element and/or at least one protrusion (126) that extends downwards.
13. Method for brewing coffee using a centrifugal coffee brewing device comprising,
   a centrifugal brewing unit constructed to brew coffee, the centrifugal brewing unit comprising:
      a chamber element comprising a bottom wall and a roof portion,
      a cylinder element comprising a filter,
   a heater element,
   a gutter element which defines a gutter located around the centrifugal brewing unit, via which the brewed coffee travels to a coffee outlet,
   a residue deflection member for guiding the coffee residue which is ejected from the centrifugal brewing unit into a residue tray, wherein the residue deflection member is heated by the heater element.
wherein the method comprises the steps:
a) injecting hot water into the centrifugal brewing unit,
b) extracting a coffee beverage from a coffee bed that has formed over the filter and ejecting the coffee beverage into the gutter element,
c) moving the filter and ejecting the coffee residue from the centrifugal brewing unit,
d) guiding the coffee residue into the residue tray with the residue deflection member, wherein the residue deflection member is heated by the heater element.
14. Method according to the previous clause, wherein the heater element also heats the gutter element and is integrated into the gutter element.

1. A centrifugal coffee brewing device, comprising:
a centrifugal brewing unit constructed to brew coffee, the centrifugal brewing unit comprising:
a chamber element comprising a bottom wall and a roof portion,
a cylinder element comprising a filter,
a residue deflection member for deflecting coffee residue which is ejected from the centrifugal brewing unit, wherein the coffee residue is deflected in a downward direction,
a skirt positioned below the residue deflection member and extending downward from the residue deflection member, wherein the skirt is configured for further guiding the deflected coffee residue downward into a residue tray,
a heater element, wherein the heater element heats the skirt, thereby preventing formation of condensation on the skirt and preventing sticking of coffee residue to the skirt.

2. The centrifugal coffee brewing device according to claim 1, wherein the skirt comprises a lower part which is constricted and which faces upwardly and wherein the heater element heats the constricted lower part, thereby avoiding formation of condensation on the constricted lower part and avoiding sticking of coffee residue to the constricted lower part.

3. The centrifugal coffee brewing device according to claim 1, wherein:
a) the heater element is integrated with the skirt or in contact with the skirt and directly heats the skirt, and/or
b) the heater element is integrated with the residue deflection member or is in contact with the residue deflection member, wherein the heater element indirectly heats the skirt via conduction of heat through the residue deflection member to the skirt.

4. The centrifugal coffee brewing device according to claim 1, wherein the skirt is heated to a temperature of at least 50 degrees Celsius by the heater element.

5. The centrifugal coffee brewing device according to claim 1, wherein the residue deflection member and the skirt are integrated and form a single ring-shaped residue guiding component, wherein the entire residue guiding component is heated by the heater element.

6. The centrifugal coffee brewing device according to claim 1, wherein the residue deflection member and the skirt are manufactured from a heat conducting material, preferably metal.

7. The centrifugal coffee brewing device according to claim 1, wherein the residue deflection member and the skirt are manufactured from aluminium.

8. The centrifugal coffee brewing device according to claim 1, wherein the heater element also heats the residue deflection member, wherein the heating of the residue deflection member prevents condensation of moisture inside the centrifugal coffee brewing device on the residue deflection member, thereby reducing sticking of expelled coffee residue to the residue deflection member.

9. The centrifugal coffee brewing device according to claim 1, further comprising a gutter element which defines a gutter located around the centrifugal brewing unit, via which brewed coffee travels to a coffee outlet, wherein the gutter and the residue deflection member are integrated into one component or wherein the residue deflection member and gutter are separate elements which are in contact with one another in order to allow heat to transfer between the residue deflection member and the gutter.

10. The centrifugal coffee brewing device according to claim 1, wherein the heater element is configured to also heat the gutter and is part of the gutter and/or in contact with the gutter.

11. The centrifugal coffee brewing device according to claim 1, wherein the residue deflection member forms an inwardly facing wall which faces inwards and downwards.

12. The centrifugal coffee brewing device according to claim 1, wherein the skirt extends to a position below a bottom wall of the chamber element.

13. The centrifugal coffee brewing device according to claim 1, wherein the residue deflection member is heated to a temperature of at least 50 degrees Celsius by the heater element.

14. The centrifugal coffee brewing device according to claim 1, wherein the heater element directly or indirectly heats the skirt.

15. (canceled)

16. The centrifugal coffee brewing device according to claim 1, wherein the residue deflection member is coated with a non-sticking material, wherein the non-sticking material is polytetrafluoroethylene, more in particular Teflon.

17. The centrifugal coffee brewing device according to claim 1, wherein the heater element is located under the gutter.

18. The centrifugal coffee brewing device according to claim 1, wherein the gutter and the residue deflection member are integrated into one component.

19. The centrifugal coffee brewing device according to claim 1, wherein the residue deflection member and gutter are separate elements which are in thermal contact with one another, wherein the heater element is part of the gutter.

20. A method for brewing coffee using a centrifugal coffee brewing device according to claim 1, wherein the method comprises the steps:
a) injecting hot water into the centrifugal brewing unit,
b) extracting a coffee beverage from a coffee bed that has formed over the filter and ejecting the coffee beverage into the gutter element,
c) moving the filter and ejecting the coffee residue from the centrifugal brewing unit,
d) guiding the coffee residue into the residue tray with the residue deflection member and the skirt, wherein the skirt is heated by the heater element, thereby preventing formation of condensation on the skirt and preventing sticking of coffee residue to the skirt.

21. The method according to claim 20, wherein the heater element also heats the gutter element and is integrated into the gutter element.

22.-83. (canceled)
